(19) United States
(12) Patent Application Publication
(10) Pub. No.: US 2026/0045858 A1
(43) Pub. Date: Feb. 12, 2026

(54) PLANAR DRIVE SYSTEM, ROTOR FOR A PLANAR DRIVE SYSTEM AND METHOD FOR ENERGY TRANSFER

(71) Applicant: Beckhoff Automation GmbH, Verl (DE)

(72) Inventors: Johannes Beckhoff, Schloß Holte-Stukenbrock (DE); Felix Schulte, Rietberg (DE); Lukas Bentfeld, Delbrück (DE); Uwe Prüssmeier, Lemgo (DE)

(21) Appl. No.: 19/355,659

(22) Filed: Oct. 10, 2025

Related U.S. Application Data
(63) Continuation of application No. PCT/EP2024/059689, filed on Apr. 10, 2024.

(30) Foreign Application Priority Data
Apr. 12, 2023 (DE) 10 2023 109 179.4

(51) Int. Cl. H02K 11/00; H02K 41/03; H02P 25/064

(52) U.S. Cl. CPC H02K 11/0094; H02K 41/031; H02P 25/064; H02K 2201/18

(57) ABSTRACT

A planar drive system comprises a stator assembly having a plurality of coil groups for generating a stator magnetic field, and at least one rotor having a plurality of magnet assemblies for generating a rotor magnetic field. The rotor can be driven on the stator assembly via a magnetic coupling between the stator magnetic field and the rotor magnetic field. The rotor comprises an energy storage, and an energy transfer structure having a transfer unit is configured on the stator assembly. The rotor also comprises a transfer counter unit which can be coupled to the transfer unit. Energy transfer from the energy transfer structure to the rotor can be achieved when the transmission element is coupled to the transfer counter element. A method is also provided for transferring energy to a rotor in the planar drive system.

### CROSS-REFERENCE TO RELATED APPLICATIONS

This patent application is a continuation of International Patent Application No. PCT/EP2024/059689, entitled “Planar Drive System, Rotor for a Planar Drive System and Method for Transmitting Energy,” filed Apr. 10, 2024, which claims the priority of German patent application DE 10 2023 109 179.4, entitled “Planarantriebssystem, Läufer für ein Planarantriebssystem und Verfahren zur Energieübertragung,” filed Apr. 12, 2023, each of which is incorporated by reference herein, in the entirety and for all purposes.

### FIELD

The application relates to a planar drive system. The application also relates to a rotor for a planar drive system. The application also relates to a method for transmitting energy to a rotor of a planar drive system.

### BACKGROUND

Planar drive systems may be used in automation technology, in particular in manufacturing technology, handling technology and process engineering. Planar drive systems may be used to move or position a moving element of a system or machine in at least two linearly independent directions. Planar drive systems may comprise a permanently energized electromagnetic planar motor having a planar stator and a rotor that may move on the stator in at least two directions.

In a permanently energized electromagnetic planar motor, a drive force is exerted upon the rotor by the magnetic interaction of energized coil groups of the stator assembly with drive magnets of a plurality of magnet arrangements of the rotor.

In such a drive system, the rotor comprises at least a first magnet assembly for driving the rotor in a first direction and a second magnet assembly for driving the rotor in a second direction which is linearly independent of the first direction, for example in a direction orthogonal to the first direction. The planar stator assembly comprises energizable first coil groups, which interact magnetically with the magnets of the first magnet assembly in order to drive the rotor in the first direction, and energizable second coil groups, which interact magnetically with the magnets of the second magnet assembly in order to drive the rotor in the second direction. The first and second coil groups may generally be energized independently of each other in order to allow for independent movements of the rotor in the first and second directions. If the conductors of the first and second groups may be energized independently of each other, at least in part, a plurality of rotors may be moved independently of each other on one stator at the same time. A correspondingly embodied planar drive system is known, for example, from DE 10 2017 131 304 A1.

Rotors of such planar drive systems are primarily embodied for transporting objects within an automation process. In addition to carrying out transport tasks, rotors may also be embodied to carry out partial processes of the automation process that go beyond simply transporting objects. For this purpose, such rotors may be equipped with corresponding process devices that are set up to carry out the respective partial processes. These may be, for example, manufacturing processes, processing processes, sorting processes or similar processes in which the objects to be transported are handled accordingly. Operation of these process devices on the rotors requires a sufficient energy supply. For this reason, the problem of being able to guarantee an energy supply to the process devices arranged on the rotors during the operation of the planar drive system and, as the case may be, during the movement of the rotors arises.

### SUMMARY

An improved planar drive system, an improved rotor for a planar drive system and an improved method for transferring energy to a rotor of a planar drive system are provided.

### EXAMPLES

According to an aspect of the application, a planar drive system is provided, wherein the planar drive system comprises a stator assembly having a plurality of coil groups for generating a stator magnetic field and at least one rotor with a plurality of magnet assemblies for generating a rotor magnetic field, wherein the rotor may be driven on the stator assembly via a magnetic coupling between the stator magnetic field and the rotor magnetic field, wherein the rotor comprises an energy storage, wherein an energy transfer structure having a transfer unit is embodied at the stator assembly, wherein the rotor comprises a transfer counter unit which may be coupled to the transfer unit, and wherein an energy transfer from the energy transfer structure to the rotor may be achieved when the transfer unit is coupled to the transfer counter unit.

This may achieve the technical advantage that an improved planar drive system may be provided. For this purpose, the planar drive system comprises at least one rotor with an energy storage unit. Furthermore, the planar drive system comprises an energy transfer structure embodied at the stator assembly. Coupling a transfer unit of the energy transfer structure with a transfer counter unit of the rotor allows for energy transfer from the energy transfer structure, wherein the energy storage unit may be charged or filled. This allows for charging or filling the rotor with energy storage with energy at any time, thus providing the energy required for internal or external applications.

According to an embodiment, the energy transfer structure comprises a contacting arm, wherein the transfer unit is embodied on the contacting arm, and wherein the contacting arm is arranged at least partially above a stator surface of the stator assembly.

This may achieve the technical advantage of allowing for a simple energy transfer from the energy transfer structure to the rotor having an energy storage. As the contacting arm of the energy transfer structure is arranged at least partially above the stator surface of the stator assembly, the rotor may be easily moved into a corresponding energy transfer position for energy transfer. Coupling of the corresponding transfer units or transfer counter units of the energy transfer structure or of the rotor, respectively, may thus be achieved exclusively by moving the rotor into the corresponding energy transfer position.

The rotor thus remains positioned on the stator assembly during the charging process and may therefore be controlled at any time and moved to other positions on the stator assembly. It is therefore not necessary to replace the energy storage unit or the entire rotor to recharge the energy storage unit. As the rotor remains permanently positioned on the stator assembly, the charging process may be interrupted at any time, for example if an urgent transfer of energy to a further rotor is required at a given time. This allows for the transport process of the objects to be transported to be further optimized.

According to an embodiment, the transfer counter unit is embodied laterally and/or at an underside facing the stator surface and/or on an upper side opposite to the underside.

This may achieve the technical advantage that the embodiment of the transfer counter unit at the rotor allows for charging of the energy storage unit on the energy transfer structure in an as simple manner as possible. By embodying the transfer counter units laterally to or below the rotor, simple coupling with the transfer unit of the energy transfer structure may be achieved by positioning the rotor in the respective intended energy transfer position. The coupling of the rotor with the energy transfer structure via the corresponding transfer units may therefore be achieved solely by actuating the rotor. Additional movable mechanisms for coupling the rotor to the energy transfer structure may thus be avoided.

According to an embodiment, the transfer unit and the transfer counter unit are embodied as induction coils.

This may achieve the technical advantage that contactless energy transfer is possible via the transfer units or transfer counter units of the energy transfer structure or the rotor, which are embodied as induction coils. This in turn simplifies the coupling of the rotor to the energy transfer structure, as the rotor only has to be moved to the predefined energy transfer position in which energy transfer between the induction coils is possible.

As the energy transfer is contactless, the control or positioning of the rotor in the energy transfer position is simplified, as the contactless coupling between the induction coils allows for a higher error tolerance in the positioning of the transfer units or transfer counter units in relation to one another.

According to an embodiment, the transfer unit and the transfer counter unit are each embodied as an induction layer, wherein the transfer unit is arranged at the stator surface of the stator assembly, and wherein the transfer counter unit is embodied at an underside of the rotor facing the stator surface.

This may achieve the technical advantage of further simplifying the coupling of the rotor with the energy transfer structure for energy transfer. The energy transfer position, in which coupling between the transfer units or transfer counter units is possible, is given by the embodiment of the transfer unit or of transfer counter unit, respectively, as induction layers through the entire surface of the transfer unit embodied as an induction layer.

The induction layer of the transfer unit is in this context arranged on the stator surface of the stator assembly. The rotor only needs to be maneuvered onto the surface of the transfer unit, which is embodied as an induction layer, to transfer energy. By embodying the induction layer of the transfer counter unit on the underside of the rotor, energy transfer may be achieved directly by positioning the rotor on the surface of the transfer unit. If the transfer unit is embodied as a flat induction layer, for example on the entire stator surface of the stator assembly, the energy transfer from the energy transfer structure to the rotor may also be made possible when the rotor is moving.

The rotor may therefore be supplied with the required amount of energy by the energy transfer structure while traveling on the stator assembly, for example while traveling to a further rotor. This allows for further optimizing the transport process, as additional delays may be reduced or avoided.

According to an embodiment, the transfer unit comprises a busbar, wherein the transfer counter unit comprises a sliding contact.

This may achieve the technical advantage of again allowing for a simplified energy transfer from the energy transfer structure to the rotor. For this purpose, the transfer unit of the energy transfer structure is embodied as a busbar, while the transfer counter unit of the rotor is embodied as a sliding contact.

The rotor may therefore travel along the busbar for energy transfer in such a way that the busbar is contacted by the sliding contact, thus tapping the required amount of energy via the sliding contact during travel. The sliding contact and the busbar also provide a robust and reliable option for energy transfer.

According to an embodiment, the busbar is embodied in a stator surface of the stator assembly, with the sliding contact being embodied on an underside of the rotor facing the stator surface.

This may achieve the technical advantage that by embodying the busbar on the stator surface and the sliding contact on the underside of the rotor, the rotor only has to travel over the busbar and automatically, for example by lowering the flying height of the rotor, contacting the sliding contact with the busbar and thus transferring energy is allowed for. This means that the rotor does not have to be moved to a dedicated energy transfer position, for example at the edge of the stator assembly, which saves even more time during the transportation process.

According to an embodiment, the busbar comprises a plurality of contacting elements, the contacting elements being arranged at predetermined distances from one another on the stator assembly, a plurality of sliding contacts arranged at a distance from one another being embodied on the rotor, and the predefined distance being defined in such a way that contact may be made between at least one contacting element and a sliding contact in a plurality of positions of the rotor on the stator assembly.

This may achieve the technical advantage that the plurality of contacting elements of the busbar, which are distributed over a flat area of the stator surface of the stator assembly and are arranged at a distance from one another in such a way that in a plurality of positions the rotor may make contact with at least one contacting element via at least one sliding contact, means that the rotor may be provided with a corresponding amount of energy by the energy transfer structure in a plurality of positions on the stator assembly.

By allowing for the rotor to be charged with energy at a variety of positions on the stator assembly, it is possible to avoid having to move the rotor to a designated energy transfer position first. This saves even more time during the transportation process. The contacting elements and the sliding contact may each comprise a + pole and a − pole. Alternatively, the contacting elements may each comprise a + pole or a − pole. If the contacting elements each comprise only one+ pole or one-pole, the contacting elements may be arranged at a distance from one another in such a way that, in any position of the rotor on the stator assembly, the rotor contacts at least one+ pole contacting element via a sliding contact and at least one-pole contacting element via a further sliding contact.

According to an embodiment, the coupling between the transfer unit of the energy transfer structure and the transfer counter unit of the rotor may be realized by varying the flying height of the rotor above the stator surface.

This may achieve the technical advantage that contact with the energy transfer structure may be achieved by varying the flying height of the rotor. A complicated process of connecting the rotor to the energy transfer structure may thus be avoided. By increasing the flying height, the rotor may terminate the energy transfer at any time. This allows for a smooth and time-saving energy transfer process.

According to an embodiment, the energy storage is arranged on a surface of the rotor or integrated into a base structure of the rotor or integrated into an edge structure of the rotor or embodied flat on the base structure of the rotor and forms the surface of the rotor.

This may achieve the technical advantage that the energy storage unit may be arranged at the rotor in an advantageous manner, depending on the application. For example, the flight behavior of the rotor may be improved with an even distribution.

By integrating the energy storage unit into the rotor base of the rotor, on the other hand, it is possible to prevent the energy storage unit from reducing the usable loading area of the rotor. This allows for a wide range of applications and allows for additional functions of the rotor having an energy storage that go beyond the supply of energy to further rotors.

According to an embodiment, the energy storage is detachably fixed to the rotor by a fixing mechanism, wherein the fixing mechanism comprises a latching connection and/or a plug connection.

This may achieve the technical advantage that the energy storage unit is securely attached to the rotor by the fixing mechanism. Due to the detachable fixation by the fixing mechanism, the energy storage unit may be replaced if necessary.

According to an embodiment, the planar drive system further comprises a trigger structure arranged at the stator assembly, wherein the trigger structure comprises an activation projection and a receiving area, wherein the fixing mechanism comprises a trigger element, and wherein the planar drive system is set up to press the trigger element against the activation projection by moving the rotor into an ejection position on the stator assembly and thereby to trigger it, wherein by triggering the trigger element, the energy storage is ejected from the fixing mechanism into the receiving region of the trigger structure.

This may achieve the technical advantage that the trigger structure embodied at the stator assembly allows for simplified exchange of the energy storage unit of the rotor. For this purpose, the rotor only needs to be positioned in a corresponding trigger position relative to the trigger structure. In the trigger position, an activation projection of the trigger structure activates a trigger element of the fixing mechanism, whereupon the energy storage is automatically ejected from the fixing mechanism into a receiving area of the trigger structure provided for this purpose. Additional movable or actuatable elements of the trigger structure, with the aid of which the energy storage may be removed from the rotor, are therefore not required to remove the energy storage from the rotor. The energy storage may therefore be removed from the rotor solely by moving the rotor to the intended trigger position.

According to an embodiment, the rotor and/or the further rotor comprises a process device, wherein the process device may be driven via the energy of the energy storage unit.

This may achieve the technical advantage that the rotor may carry out corresponding processes during the transport of the objects to be transported by operating the process device. The transport process of the objects to be transported may thus be further optimized.

According to an embodiment, the energy storage system comprises an electric battery unit and/or a compressed air tank and/or a vacuum tank and/or a gas tank and/or a fuel tank.

This may achieve the technical advantage that different types of energy may be provided by the energy storage system of the rotor in order to operate the process devices. This means that different process devices and different processes may be carried out on the rotors.

According to an embodiment, the rotor comprises an energy transfer element connected to the energy storage, wherein the energy transfer element may be coupled to an energy transfer counter element of a further rotor, and wherein an energy transfer from the rotor to the further rotor may be achieved when the energy transfer element is coupled to the energy transfer counter element.

This may achieve the technical advantage that the energy stored in the energy storage unit may be made available to a further rotor of the planar drive system via the rotor. This allows for a transfer of energy between rotors of the planar drive system. At least one of the rotors must be equipped with a corresponding energy storage unit for this purpose.

The rotors may, for example, comprise process devices that are installed on the respective rotors and may be executed. The execution of the process devices may be achieved, for example, during the movement of the rotors or the transportation of objects by the rotors. The execution of the process devices allows for executing corresponding processes on the rotor, such as the production, processing or machining of objects to be transported.

The energy may also be transferred from the rotors to a process device that is not positioned on a rotor.

The processes carried out by the process devices may include, for example, the tempering of objects to be transported, the mixing or demixing or the sorting or gripping of objects, which may be carried out while the respective objects are being transported by the rotor.

The rotor embodied with the energy storage unit may thus supply rotors with process devices in any position on the stator assembly with the corresponding energy for executing the process devices if the respective rotors require corresponding energy to operate the process device.

The energy transfer from the energy storage unit of the rotor to the respective further rotor may, for example, be carried out during the process of the two rotors. The rotor equipped with the energy storage may thus be used as a so-called tank rotor, which is controlled towards the respective rotors that require a corresponding amount of energy to execute the respective process devices. The tank rotor may thus avoid the need of controlling the respective rotors to designated tank positions or energy transfer positions for energy transfer, which would unnecessarily delay the transportation process of the respective objects to be transported.

Instead, during the transportation of the objects to be transported by the rotors, the tank rotor may be coupled with the respective other rotor and the corresponding amount of energy required may be transferred to the further rotor. This may easily be carried out while the two rotors are moving so that a delay in the transportation process may be prevented.

According to an embodiment, the energy transfer element of the rotor and the energy transfer counter element of the further rotor are each embodied as a plug connection with a plug element and/or a socket element or as an induction coil.

This may achieve the technical advantage that the plug connection of the energy transfer elements or energy transfer counter elements of the rotor or of the further rotor, which are embodied as plug or socket elements, allows for a secure coupling of the two rotors and thus for a secure energy transfer. The plug connection achieves a robust coupling of the two rotors.

This facilitates energy transfer, for example during movement of the two rotors on the stator assembly. The plug connection may be achieved by moving one of the two rotors onto the respective other rotor in such a way that the plug element is inserted into the respective socket element of the other rotor. A complicated coupling process between the two rotors may thus be avoided.

The robustness of the plug connection makes it easier to control the two rotors, for example if the energy transfer process is to be carried out while the two rotors are moving. The two rotors are coupled to each other via the plug connection. This makes it easier to position the two rotors in relation to each other, especially if the coupling is to be maintained while the two rotors are moving.

By embodying the energy transfer elements or energy transfer counter elements as induction coils, a simplified coupling of the two rotors for energy transfer may be achieved. The positioning of the two rotors relative to each other for the purpose of coupling may thus be simplified by the contactless energy transfer, since a higher error tolerance in the positioning of the energy transfer elements or energy transfer counter elements of the two rotors is permitted due to the contactless energy transfer.

As an alternative, the planar drive system may have a plurality of rotors having energy transfer elements and/or energy transfer counter elements. The plurality of rotors may be coupled to or with one another via the energy transfer elements and/or energy transfer counter elements, so that energy transfer is possible via a series of more than two rotors coupled to one another. Of the plurality of rotors, more than one rotor or all rotors may be provided with energy storage elements. During energy transfer, a plurality of rotors may therefore contribute energy to the amount of energy to be transferred. In this way, an amount of energy may be transferred to one or a plurality of rotors that exceeds the amount of energy that may be stored in an energy storage of a single rotor.

According to an aspect, a rotor is provided for a planar drive system according to any one of the preceding embodiments, wherein the rotor comprises at least one energy storage element and one energy transfer element.

This may provide the technical advantage of providing an improved rotor that may be used in a planar drive system according to the embodiments described above and the corresponding technical advantages.

According to an aspect, a method for transferring energy to a rotor in a planar drive system according to any one of the preceding embodiments is provided, wherein the planar drive system comprises a controller, a stator assembly and a rotor, wherein an energy transfer structure with a transfer unit is embodied on the stator assembly, wherein the rotor comprises a transfer counter unit couplable to the transfer unit, and wherein the method comprises:
outputting of control signals by the controller to at least one coil group of the stator assembly for positioning the rotor in an energy charging position relative to the energy transfer structure in a first outputting step, wherein in the energy charging position a coupling between the transfer unit of the energy transfer structure and the transfer counter unit of the rotor and an energy transfer from the energy transfer structure to the rotor associated with the coupling may be achieved; and
outputting of control signals by the controller to the energy transfer structure for carrying out the energy transfer from the energy transfer structure to the rotor in a second outputting step.

This may achieve the technical advantage of providing an improved method for transferring energy to a rotor. For this purpose, the rotor having an energy storage is moved into an energy charging position relative to the energy transfer structure. In the energy charging position, the transfer unit of the energy transfer structure may be coupled to the transfer counter unit of the rotor and energy may be transferred from the energy transfer structure to the rotor. The energy charging position may vary depending on the embodiment of the energy transfer structure and, in particular, depending on the embodiment of the transfer units and counter transfer units.

According to an embodiment, the first outputting step comprises:
outputting control signals via the controller to at least one coil group for varying a flying height of the rotor in the energy loading position and for coupling the transfer unit of the energy transfer structure and the transfer counter unit of the rotor in a third outputting step.

This may achieve the technical advantage that by varying the flying height of the rotor relative to the stator assembly, an optimum coupling of the transfer unit of the energy transfer structure and the transfer counter unit of the rotor is possible. This in turn may lead to optimum energy transfer from the energy transfer structure to the rotor.

According to an embodiment, the method further comprises:
outputting of control signals via the controller to at least one coil group for controlling the rotor into an ejection position in a fourth outputting step, wherein in the ejection position a trigger element of a fixing mechanism, with the aid of which the energy storage is fixed to the rotor, adjoins an activation projection of a trigger structure arranged on the stator assembly and is triggered thereby, and wherein by triggering the trigger element the energy storage is ejected from the fixing mechanism and is picked up by a receiving region of the trigger structure.

This may achieve the technical advantage of allowing for a simplified removal of an energy storage from a rotor by moving the rotor to a designated ejection position relative to the trigger structure. Additional elements that may be actuated are therefore not required to remove an energy storage from a rotor.

According to an embodiment, the method further comprises:
outputting of control signals by the controller to at least one coil group of the stator assembly for positioning the rotor in a transfer position relative to a further rotor of the planar drive system in a fifth outputting step, wherein in the transfer position a coupling between an energy transfer element of the rotor with an energy transfer counter element of the further rotor and an energy transfer from the rotor to the further rotor and/or an energy transfer from the further rotor to the rotor may be achieved; and
carrying out the energy transfer from the rotor to the other rotor and/or from the other rotor to the rotor in one transferring step.

This may achieve the technical advantage that the coupling between the rotor and the further rotor allows for energy to be transferred between the rotors of the planar drive system. If one of the rotors of the planar drive system requires a quantity of energy, for example to execute a process device, this may be provided by a further rotor. The rotor requiring the amount of energy therefore does not necessarily have to be moved to a corresponding energy transfer structure in order to carry out a corresponding energy transfer, but may be supplied with energy directly by another rotor. For this purpose, either the rotor requiring the energy may travel to a rotor that may provide a corresponding amount of energy. Alternatively, the rotor providing the amount of energy may be moved to the rotor requiring the energy in order to carry out the energy transfer.

The control of the rotors and, in particular, the recognition that a rotor requires energy to execute a process device and the determining of a rotor that is able to provide the required amount of energy may be achieved by the controller. For this purpose, the controller may have access to corresponding information regarding the amount and type of energy available to a rotor. As an alternative or in addition, the rotors may indicate the respective energy status to the controller by sending corresponding messages.

This allows for an efficient transportation process, as the energy-requiring rotors may be supplied with the appropriate amount of energy without having to be moved to a predefined charging position.

According to an embodiment, the energy transfer from the rotor to the further rotor or from the other further to the rotor is controlled by the rotor or the controller.

This may achieve the technical advantage of allowing for precise control of the energy transfer between the rotors. The controller may control the energy transfer by sending corresponding control signals to the rotors. Alternatively, the rotors control the energy transfer independently. For this purpose, the rotors may each comprise an internal communication unit and a controller via which, on the one hand, data communication between the rotors may be carried out and the energy transfer may be achieved.

According to an embodiment, the controller recognizes that the rotor and/or the further rotor requires an amount of energy and that an energy transfer is to be carried out, and/or that the rotor and/or the further rotor is able to provide a corresponding amount of energy, and/or wherein the rotor and/or the further rotor signal to the controller that an amount of energy is required and that an energy transfer is to be carried out by sending a corresponding message to the controller.

This may achieve the technical advantage of allowing for precise energy transfer between the rotors. For this purpose, the controller may have access to the information regarding the energy supply states of the individual rotors and use this to recognize when a rotor requires energy, for example in order to execute a process device, and which rotor may provide a corresponding amount of energy. The controller may then output corresponding control signals to effect an energy transfer.

However, the information regarding the energy supply status may also be sent directly to the controller by the rotors. The rotors may request an energy transfer directly from the controller, which may then be initiated by the controller. This allows for a reliable transfer of energy, in which the energy may be provided to the rotors immediately when required.

Furthermore, the rotors may indicate to the controller how much energy the respective rotor may provide during an energy transfer, for example upon request by the controller.

According to an embodiment, the rotor is coupled to the other rotor and the energy is transferred from the rotor to the further rotor while the rotor and the further rotor are moving.

This may achieve the technical advantage that the transfer of energy from the rotor to the further rotor while both rotors are moving allows for the fact that the transport process of the objects to be transported by the other rotor does not have to be interrupted by the energy transfer. This allows the transport process to be further optimized.

### BRIEF DESCRIPTION OF THE DRAWINGS

The application is described in more detail with reference to the attached figures, in which:

FIG. 1 shows a schematic depiction of a planar drive system having a stator assembly and two rotors according to an embodiment;

FIG. 2 shows a schematic depiction of a stator module of the stator assembly of FIG. 1;

FIG. 3 is a schematic depiction of the underside of a rotor according to an embodiment;

FIGS. 4A and 4B show further schematic depictions of a planar drive system having a stator assembly and two rotors in two different coupling states according to a further embodiment;

FIGS. 5A-5D show various schematic depictions of a rotor with an energy storage according to an embodiment;

FIG. 6 is a schematic depiction of a planar drive system having a stator assembly, a rotor and an energy transfer structure according to a further embodiment;

FIGS. 7A and 7B show two further schematic depictions of a planar drive system having a stator assembly, a rotor and an energy transfer structure according to a further embodiment;

FIG. 8 is a further schematic depiction of a planar drive system having a stator assembly, a rotor and an energy transfer structure according to a further embodiment;

FIG. 9 is a further schematic depiction of a planar drive system having a stator assembly, a rotor and an energy transfer structure according to a further embodiment;

FIG. 10 shows a further schematic depiction of a planar drive system having a stator assembly, a rotor and an energy transfer structure according to a further embodiment;

FIG. 11 shows a further schematic depiction of a planar drive system having a stator assembly, a rotor and an energy transfer structure according to a further embodiment;

FIG. 12 is a further schematic depiction of a planar drive system having two stator assemblies, a rotor and an energy transfer structure according to a further embodiment;

FIG. 13 is a further schematic depiction of a planar drive system having two stator assemblies, a rotor and an energy transfer structure according to a further embodiment;

FIG. 14 is a further schematic depiction of a planar drive system having a stator assembly, a rotor and an energy transfer structure according to a further embodiment;

FIGS. 15A-15C show a schematic top view and two schematic sectional views of a planar drive system having a stator assembly, a rotor and an energy transfer structure according to a further embodiment;

FIGS. 16A and 16B show two further schematic depictions of a rotor having an energy storage according to two further embodiments;

FIG. 17 is a schematic depiction of a planar drive system having a stator assembly, a rotor and a trigger structure according to an embodiment;

FIG. 18 shows a flowchart of a method for transferring energy to a rotor of a planar drive system according to an embodiment; and

FIG. 19 shows a flowchart of a method for transferring energy to a rotor of a planar drive system according to an embodiment.

### DETAILED DESCRIPTION

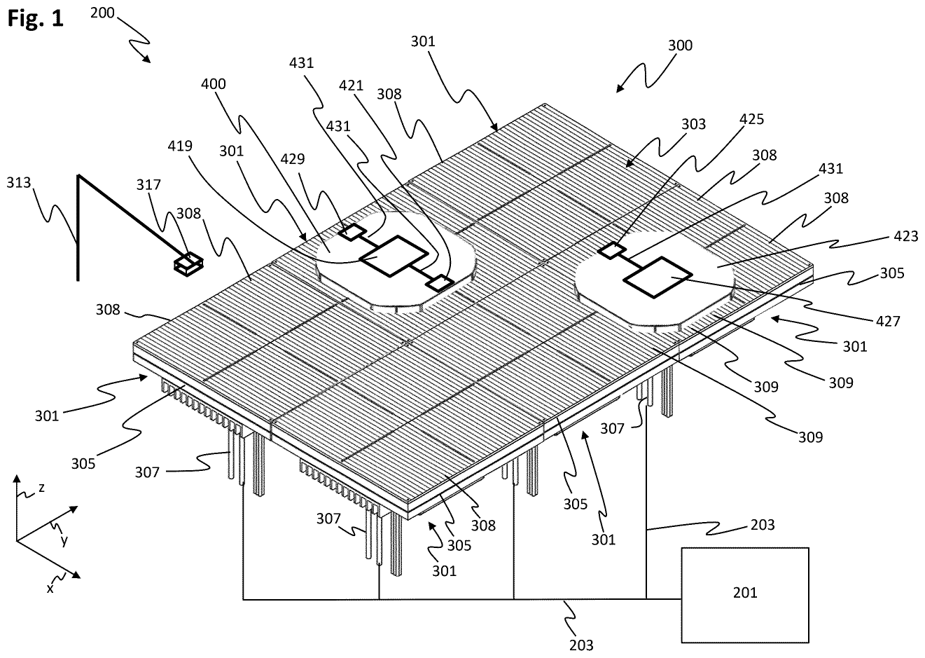

FIG. 1 shows a schematic view of a planar drive system 200 having a stator assembly 300 and a rotor 400.

According to the embodiment in FIG. 1, the planar drive system comprises a controller 201, a stator assembly 300, a rotor 400 and a further rotor 423. The controller 201 is connected to the stator assembly 300 via a data connection 203. The controller 201 is set up to actuate the rotors 401, 421 on the stator assembly 300 and to move them thereon.

In the embodiment shown, the stator assembly 300 comprises a plurality of stator modules 301 arranged side by side along an X-direction and a Y-direction of the stator assembly 300 and forming a contiguous planar stator surface 303 of the stator assembly 300. In the embodiment shown, the stator assembly 300 comprises six stator modules 301. However, the number of interconnected stator modules 301 of a stator assembly 300 should not be limited to this and may vary as desired.

Thus, a stator assembly 300 according to the application may comprise only one stator module 301, but also a plurality of arbitrarily arranged connected stator modules 301, which then form a contiguous stator surface 303. In the embodiment shown, the controller 201 is connected to each stator module 301 in such a way that each stator module 301 may be actuated individually. In FIG. 1, not all connections to all stator modules 301 are visible due to the perspective view.

In the embodiment shown, each of the stator modules 301 comprises four stator segments 308. Each stator segment comprises X-coil groups and Y-coil groups, each of which is oriented along the X-direction or the Y-direction. Alternatively, the stator modules 301 may comprise a different number of stator segments 308.

In the embodiment shown, the stator segments 308 have a square embodiment and are arranged in alignment with one another along the X-direction and the Y-direction. Each stator segment 308 comprises a plurality of energizable stator conductors 309, which are combined in the coil groups and are oriented along the X-direction or along the Y-direction. Stator magnetic fields may be generated by energizing the stator conductors 309 of the coil groups.

With the aid of a magnetic coupling between the stator magnetic fields and a rotor magnetic field of the rotor 400, the rotor 400 may be moved over the stator surface 303 in a floating manner at least along the X-direction, the Y-direction or a combined XY-direction. It is also possible to move the rotor 400 in a Z-direction oriented perpendicular with regard to the X-direction and the Y-direction. In this way, the distance between the rotor 400 and the stator surface 303 may be varied, i.e. the rotor 400 may be raised or lowered above the stator surface 303.

The stator modules 301 each comprise a stator module housing 305 in which control electronics are arranged for actuating the stator module 301, in particular for controlling the energization of the individual coil groups. Furthermore, magnetic field sensors for detecting the rotor magnetic field of the rotor 400 are arranged in the stator module housing 305. Each stator module 301 comprises corresponding connection lines 307 for supplying power and data to the control electronics.

According to the application, the rotor 400 further comprises an energy storage unit 419 and a transfer counter unit 429 connected to the energy storage unit 419. In the embodiment shown, the counter transfer unit 429 is connected to the energy storage unit 419 via an energy transfer connection 431.

The planar drive system 200 further comprises an energy transfer structure 313 having a transfer unit 317. The transfer unit 317 of the energy transfer structure 313 may be coupled to the transfer counter unit 429 of the rotor 400. By coupling the transfer unit 317 and the transfer counter unit 429, it is possible to transfer energy from the energy transfer structure 313 to the rotor 400. The transferred energy may then be stored in the energy storage unit 419 of the rotor 400.

In the embodiment shown, the energy transfer structure 313 is arranged next to the stator assembly 300 and may be contacted by the rotor 400 by moving the rotor 400 to a position suitable for energy transfer.

In the embodiment shown, the energy transfer structure 313 shown in FIG. 1 is merely exemplary in the respective embodiment. In a further embodiment, the energy transfer structure 313 may also be embodied differently.

The planar drive system 200 may also comprise a plurality of energy transfer structures 313, which are embodied at various points on the stator assembly 300. The rotor 400 may thus contact an energy transfer structure 313 at various points and be supplied with energy.

The energy transfer structure 313 may also be arranged over an extended area on the stator assembly 300. The rotor 400 may thus be supplied with energy when passing the energy transfer structure 313.

According to an embodiment, the rotor 400 may have a plurality of transfer counter units 429. These may, for example, be embodied at different locations on the rotor 400. The rotor 400 may thus make contact with the respective energy transfer structure 313 in different orientations relative to the stator assembly 300.

Alternatively, the rotor 400 may simultaneously contact multiple energy transfer structures 313.

The energy provided by the energy transfer structure 313 and storable in the energy storage 419 may be of different types of energy. For example, the energy provided by the energy transfer structure 313 may be an electrical energy, a chemical energy, a thermal energy or a potential energy or a kinetic energy.

The energy storage 419 may be embodied accordingly to receive and store the type of energy provided by the energy transfer structure 313. The energy storage 419 may thus be configured as a battery unit for storing electrical energy. Alternatively, the energy storage 419 may be configured as a media storage device for storing an energy transfer medium.

The energy transfer medium may, for example, be a fuel in the form of a combustible fluid, such as a combustible gas like hydrogen or a combustible liquid like oil or gasoline. Alternatively, the energy transfer medium may be a fluid as a carrier of a quantity of heat. Alternatively, the energy transfer medium may be a pressurized gas, such as compressed air. Alternatively, the energy storage 419 may comprise a corresponding storage device for storing mechanical energy. This storage device may, for example, be embodied as a flywheel.

The energy storage 419 may also be embodied to store different types of energy. For this purpose, the energy storage 419 may have different sections in which the different types of energy may be stored.

The energy transfer connections 431 between the energy storage unit 419 and the transfer counter unit 429 and the energy transfer element 421 are embodied accordingly to transmit the energy provided to or from the energy storage unit 419. Depending on the respective type of energy, the energy transfer connections 431 may be embodied as cables for transmitting electrical energy or as pipes or hoses for transmitting the energy transfer medium.

The energy transfer structure 313 is embodied accordingly to transfer the energy to the rotor 400. Thus, the transfer unit 317 may be embodied as an electrical plug element for transmitting electrical energy or as a nozzle element for transmitting the energy transfer medium.

The energy transfer structure 313 may also be arranged to transfer various forms of energy to the rotors 400. For example, the energy transfer structure 313 may include a plurality of transfer units 317 for transferring electrical energy and/or chemical energy and/or thermal energy and/or potential energy and/or kinetic energy.

Accordingly, the rotor 400 may comprise a plurality of transfer counter units 429 comprising a transfer of electrical energy and/or chemical energy and/or thermal energy and/or potential energy and/or kinetic energy. Accordingly, the energy storage unit 419 may comprise a plurality of units that allow for simultaneously storing electrical energy and/or chemical energy and/or thermal energy and/or potential energy and/or kinetic energy.

In the embodiment shown, the rotor 400 further comprises an energy transfer element 421 connected to the energy storage 419. In the embodiment shown, the energy transfer element 421 is connected to the energy storage 419 via an energy transfer connection 431.

In the embodiment shown, the further rotor 423 comprises an energy transfer counter element 425 that may be coupled to the energy transfer element 421 of the rotor 400. The further rotor 423 further comprises a process device 427 connected to the energy transfer counter element 425 via a further energy transfer connection 431.

The energy storage 419 is used to store energy on the rotor 400. By coupling the two rotors 400, 423 via the energy transfer element 421 and the corresponding energy transfer counter element 425, the energy from the energy storage 419 may be transferred from the rotor 400 to the further rotor 423 and used on the further rotor 423 to operate the process device 427.

According to the application, such a process device 427 is used to carry out a technical process on the further rotor 423. The technical process may be, for example, a manufacturing and/or processing of an object to be transported on the further rotor 423. The process device 427 may comprise, for example, a heater or cooler for heating or cooling the object to be transported.

As an alternative or in addition, the process device 427 may comprise a mixer or demixer for mixing or demixing objects or substances. Furthermore, the process device 427 may comprise a sorting or loading/unloading device. For example, the process device 427 may comprise a gripper arm for unloading or loading objects from the further rotor 423 onto the further rotor 423 or for holding, orienting or aligning the objects on the rotor 400. The above-mentioned examples are not limiting. Various devices may be realized on the further rotor 423.

As an alternative to the embodiment shown, a corresponding process device 427 may also be embodied on the rotor 400, which may be operated using the energy from the energy storage 421. Furthermore, a corresponding energy storage may be embodied on the further rotor 423. Energy may then be transferred from the rotor 400 to the further rotor 423, for example, if the energy of the energy storage on the further rotor 423 is not sufficient to execute the process device 427.

The statements made in the following description of the rotor 400 or the further rotor 423 therefore always apply to the rotor 400 as well as to the further rotor 423 and may be combined with each other as desired.

Both the rotor 400 and the further rotor 423 may also comprise further energy transfer elements 421 and/or energy transfer counter elements 425. As a result, simultaneous coupling with a plurality of rotors 400, 423 is possible for each rotor 400, 423. In this way, energy transfer may be achieved via a plurality of rotors 400, 423 coupled to one another.

Energy of different types may also be transferred simultaneously via the multiple energy transfer elements 421 or energy transfer counter elements 425. For example, electrical and chemical or thermal energy may be transferred simultaneously from the rotor 400 to the further rotor 423.

The energy transfer elements 421 or energy transfer counter elements 425 are embodied to transfer energy of different types.

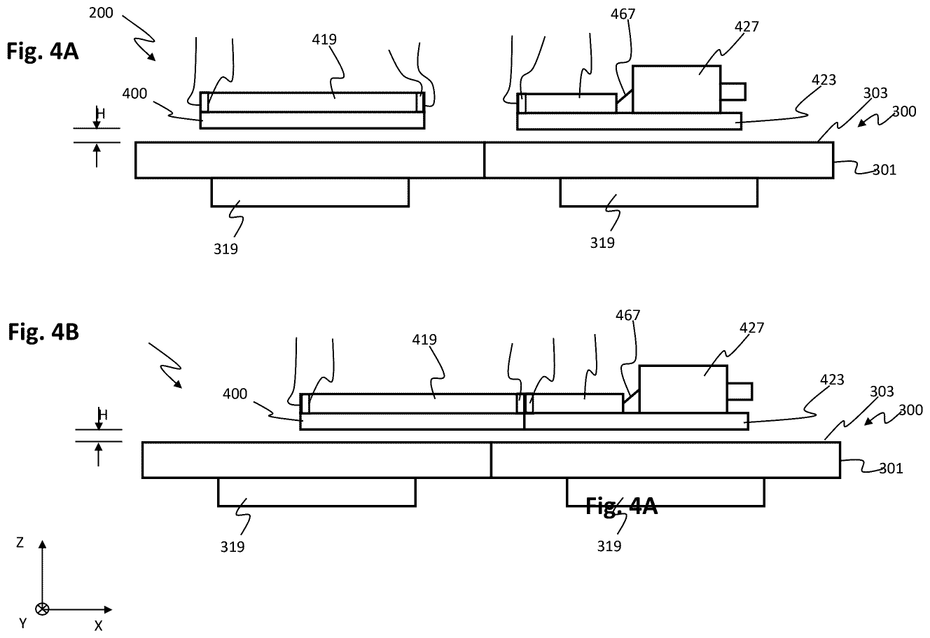

For a detailed description of the energy storage 419 and the arrangement or use of the energy storage 419 on the rotor 400, reference is made to the description of FIGS. 4A and 4B to FIG. 19.

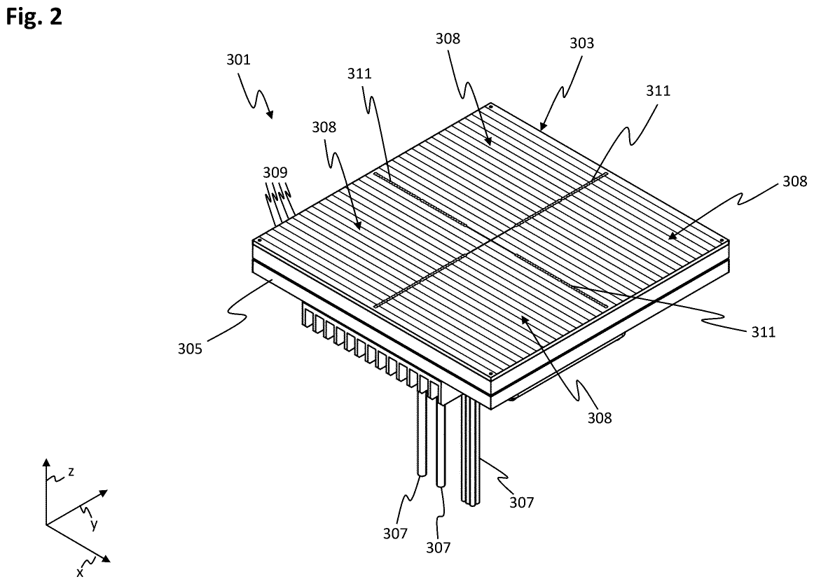

FIG. 2 shows a schematic view of a stator module 301 of the stator assembly 300 of FIG. 1.

In the embodiment shown, the stator module 301 comprises four stator segments 308 with stator conductors 309 oriented along the X direction. The stator conductors 309 may be arranged in an electrically insulated manner with regard to one another. The four stator segments 308 are square and form a square stator surface 303. The stator segments 308 are separated by a contact structure 311, which allows for a connection of the stator conductors 309 to the actuation electronics and a compact structure of the stator assembly 300.

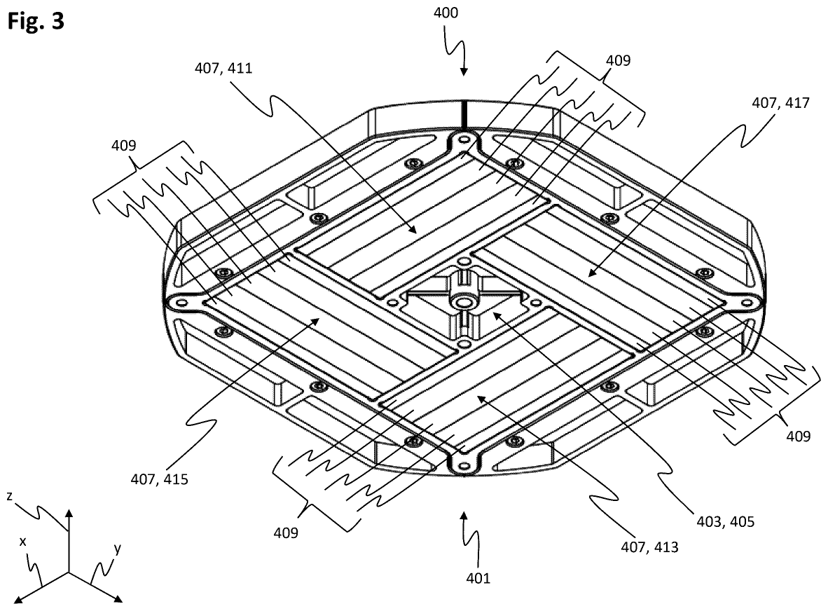

FIG. 3 shows a schematic depiction of an underside of a rotor 400 of FIG. 1 according to an embodiment.

During operation of the planar drive system 200, the underside of the rotor 400 is arranged facing the stator surface 303 of the stator assembly 300. On the underside, the rotor 400 comprises a magnet arrangement 401 having four magnet assemblies 407, i.e. a first X magnet assembly 411, a second X magnet assembly 413, a first Y magnet assembly 415 and a second Y magnet assembly 417. Each magnet assembly 407 in turn comprises a plurality of magnet elements 409. In the embodiment shown, each magnetic unit 407 comprises five magnetic elements 409, which are embodied as rectangular, elongated elements.

For example, the magnet assemblies 407 may each be embodied as a Halbach array magnet assembly. The magnet arrangement 401 is embodied to generate the rotor magnetic field of the rotor 400, via which a magnetic coupling with the stator magnetic fields of the stator assembly 300 may be achieved. The magnetic coupling may be used to control or move the rotor 400 relative to the stator assembly 300.

In the embodiment shown, the first X magnet assembly 411 and the second X magnet assembly 413 are each oriented in parallel with regard to an X direction of the rotor 400, while the first Y magnet assembly 415 and the second Y magnet assembly 417 are oriented along a Y direction. In operation, the first and second X magnet assemblies 411, 413 serve to drive the rotor 400 along the Y direction of the rotor 400, and the first and second Y magnet assemblies 415, 417 serve to drive the rotor 400 in the X direction in operation. In addition, the magnet assemblies 407 are used to drive the rotor 400 in a Z-direction oriented perpendicular with regard to the X-direction and the Y-direction or to perform rotations and tilting movements of the rotor 400.

In the center of the magnet arrangement 401, the rotor 400 may have a free surface 403 that is not covered by magnets of the magnet arrangement 401. In the area of the free surface 403, the rotor 400 may have a fastening structure 405.

FIGS. 4A and 4B show further schematic depictions of a planar drive system 200 having a stator assembly 300 and two rotors 400, 423 according to a further embodiment in two coupling states.

FIGS. 4A and 4B are a schematic side views of the planar drive system 200 from FIG. 1.

The rotor 400 comprises the energy storage 419. An energy transfer element 421 and an energy transfer counter element 425 are arranged on the energy storage 419. The two elements are each arranged on two opposite lateral areas 463 of the rotor 400.

The further rotor 423 comprises the process device 427. In the embodiment shown, the further rotor 423 further comprises a further energy storage 465. The further energy storage 465 is connected to the process device 427 via a further energy transfer connection 467. A further energy transfer counter element 425 is also arranged on the further energy storage 465.

In FIG. 4A, the two rotors 400, 423 are not arranged in the transfer position relative to one another and the energy transfer elements 421 or energy transfer counter elements 425 of the two rotors 400, 423 are not coupled to one another.

In the embodiment shown, the stator assembly 300 comprises two stator modules 301. Each stator module 301 comprises a stator base 319. The stator conductors 309 or the coil groups, with the aid of which the stator magnetic field for actuating the rotors 400, 423 may be generated, as well as the controller 201, as in the illustration shown.

The rotors 400, 423 each comprise the magnetic units described above, with the aid of which the corresponding rotor magnetic field may be generated. Due to the magnetic coupling of the rotor magnetic fields of the two rotors 400, 423 with the stator magnetic field of the stator assembly 300, the rotors 400, 423 may be moved at a flying height H above the stator assembly 300.

In FIG. 4B, the two rotors 400, 423 are arranged in the transfer position relative to one another. The transfer position of the rotors 400, 423 relative to each other does not define an absolute position of the two rotors 400, 423 relative to the stator assembly 300, but is characterized by the fact that a coupling of at least one energy transfer element 421 of the rotor 400 with at least one energy transfer counter element 425 of the further rotor 423 is made possible or has taken place.

Energy transfer is thus also possible while the two rotors 400, 423 are moving. For this purpose, the two rotors 400, 423 may be controlled in such a way that the two rotors 400, 423 are pressed against each other with a defined force in order to effect the coupling of the energy transfer elements 421 and energy transfer counter elements 425.

The energy transfer elements 421 or energy transfer counter elements 425 may be embodied as plug/socket elements, for example. A coupling of the energy transfer elements 421 or energy transfer counter elements 425 may be realized via a plug connection.

The energy transfer elements 421 or energy transfer counter elements 425 may furthermore be embodied as nozzle elements or corresponding receiving elements, with the aid of which high-pressure air or gasoline or other energy-transferring media may be transferred.

As an alternative or in addition, the energy transfer elements 421 or energy transfer counter elements 425 may comprise induction coils. The energy transfer of the energy of the energy storage 419 of the rotor 400 to the rotor 423 may in this context be achieved via a contactless energy transfer with the aid of the induction coils. A transfer position of the two rotors 400, 423 relative to one another may be defined in such a way that a contactless energy transfer between the respective induction coils of the two rotors 400, 423 is made possible in the respective positioning of the two rotors 400, 423 relative to one another.

The energy storage unit 419 or the further energy storage unit 465 may, for example, be embodied as a battery unit for storing electrical energy. As an alternative or in addition, the energy storage units 419, 465 may comprise gasoline or oil storage units, compressed air storage units or storage units for other energy-transmitting media. The process devices 427 may be embodied accordingly in order to be operated with the respective type of energy provided by the energy storage units 419, 465.

For example, the process device 427 may include a heater/cooling element for heating or cooling an object to be transported. As an alternative or in addition, the process device 427 may comprise a gripper arm, a loading/unloading device, a sorting device, a mixing/unmixing device or a similar device for performing an automation process.

In order to transfer the energy from the energy storage unit 419 of the rotor 400 to the additional rotor 423, the controller 201 may issue corresponding commands to the rotor 400 or the additional rotor 423. As an alternative or in addition to this, data communication may be realized between the rotors 400, 423, via which an energy transfer from the rotor 400 to the further rotor 423 may be achieved independently of the controller 201. For this purpose, the rotors 400, 423 may comprise corresponding controllers 201 and communication elements, with the aid of which the communication and the energy transfer or the data communication between the rotors 400, 423 may be realized.

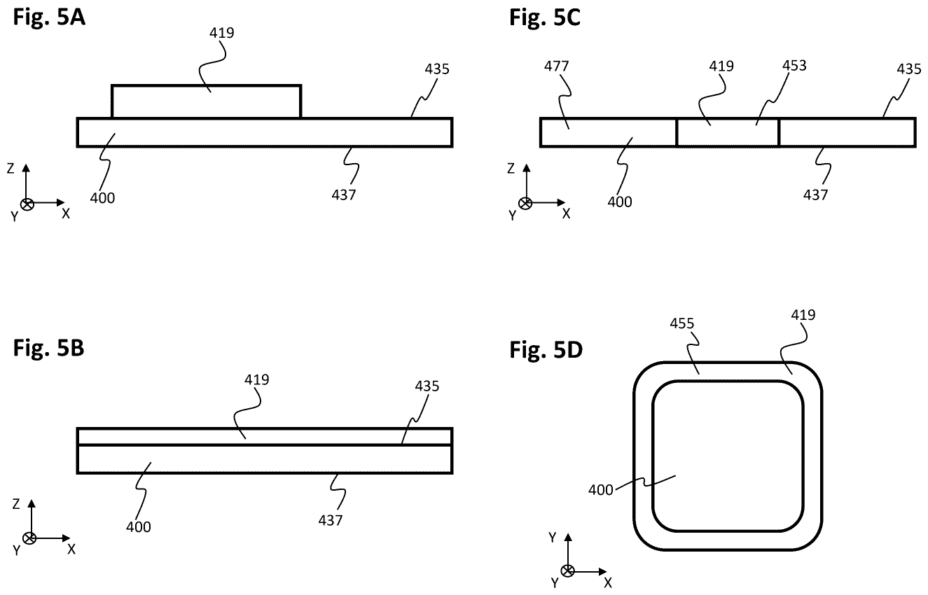

FIGS. 5A-5D show four different schematic depictions of a rotor 400 with an energy storage 419 according to an embodiment.

FIGS. 5A-5D show four different embodiments of the energy storage unit 419 described above on the rotor 400. In FIG. 5A, the energy storage 419 is arranged on an upper side 435 of the rotor 400. The arrangement of the energy storage 419 on the upper side 435 of the rotor 400 may take place at different positions on the upper side 435 depending on the application of the rotor 400.

In FIG. 5B, the energy storage 419 is embodied over the entire upper side 435 of the rotor 400.

In FIG. 5C, the energy storage 419 is integrated centrally at a center 453 of the rotor 400 in a rotor base 477 of the rotor 400. The rotor base 477 of the rotor 400 in this context comprises the components arranged within a housing of the rotor 400. The energy storage 419 may thus be installed within the housing of the rotor 400.

In FIG. 5D, the energy storage 419 is integrated in a surrounding structure 455 of the rotor 400.

As an alternative to the examples shown here, the energy storage 419 may be arranged at other positions on or in the rotor 400, depending on the respective embodiment of the energy storage 419 and/or depending on the respective application of the rotor 400.

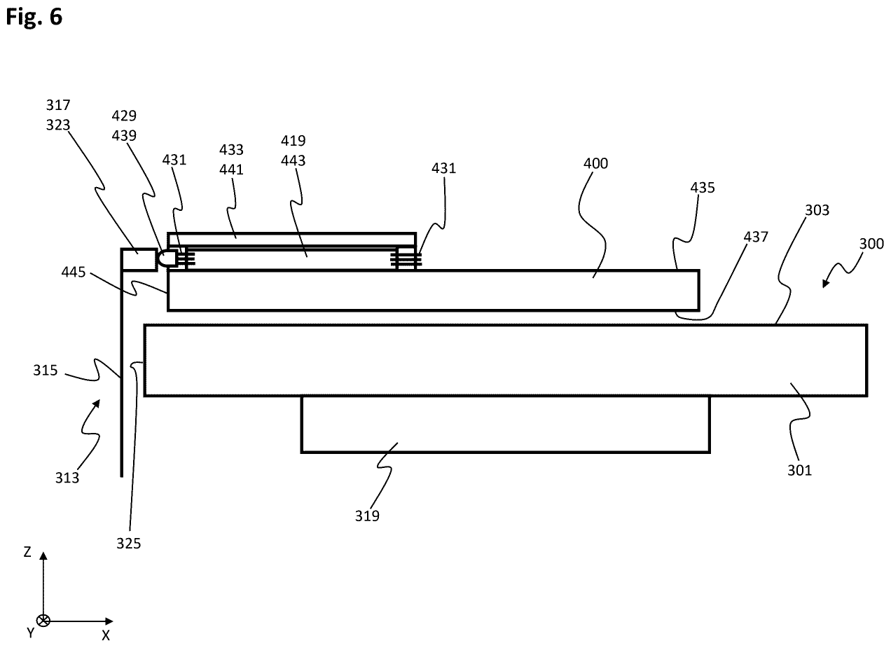

FIG. 6 shows a schematic depiction of a planar drive system 200 having a stator assembly 300, a rotor 400 and an energy transfer structure 313 according to an embodiment.

In the embodiment shown, the energy storage 419 is arranged in a fixing mechanism 433 at the rotor 400. In the fixing mechanism 433, the energy storage 419 is fixed to the rotor 400. In the embodiment shown, the fixing mechanism 433 is embodied as a housing 441.

In the embodiment shown, the energy storage unit 419 is also embodied as a battery unit 443. Furthermore, energy transfer connections 431 are embodied on the energy storage unit 419, with the aid of which the energy storage unit 419 may be electrically connected to further components.

In the embodiment shown, the energy storage unit 419 is connected to a transfer counter unit 429 via an energy transfer connection 431.

The energy storage 419 of the rotor 400 may be connected to a transfer unit 317 of an energy transfer structure 313 via the transfer counter unit 429. In the embodiment shown, the energy transfer structure 313 is embodied at a lateral area 325 of the stator assembly 300. The energy storage unit 419 of the rotor 400 may be charged with energy via the energy transfer structure 313.

In the embodiment shown, the energy transfer structure 313 comprises a contacting arm 353 and the transfer unit 317 embodied on the contacting arm 353.

In the embodiment shown, the transfer unit 317 is embodied as a busbar 323. The transfer counter unit 429 of the rotor 400 is also embodied as a sliding contact 439.

In the embodiment shown, the sliding contact 439 is arranged on a lateral area 445 of the rotor 400.

By moving the rotor 400 along the busbar 323 of the energy transfer structure 313, in which a sliding contact is made between the sliding contact 439 and the busbar 323, energy may thus be transferred from the energy transfer structure 313 to the energy storage unit 419 of the rotor 400, thereby charging the battery unit 443 of the energy storage unit 419 accordingly.

Furthermore, energy may also be transmitted when the rotor 400 is stationary as long as the busbar 323 is contacted by the sliding contact 439.

As an alternative to the embodiment shown, the sliding contact 439 may comprise two contact elements spaced apart from each other along the z-direction of the coordinate system shown. The busbar 323 may also comprise two rail elements spaced apart from one another along the z-direction. The two contact elements are embodied in such a way that a rail element is contacted by exactly one contact element in each case.

In the embodiment shown, the contacting arm 353 is rectilinear and extends perpendicular with regard to the stator surface 303 of the stator assembly 300.

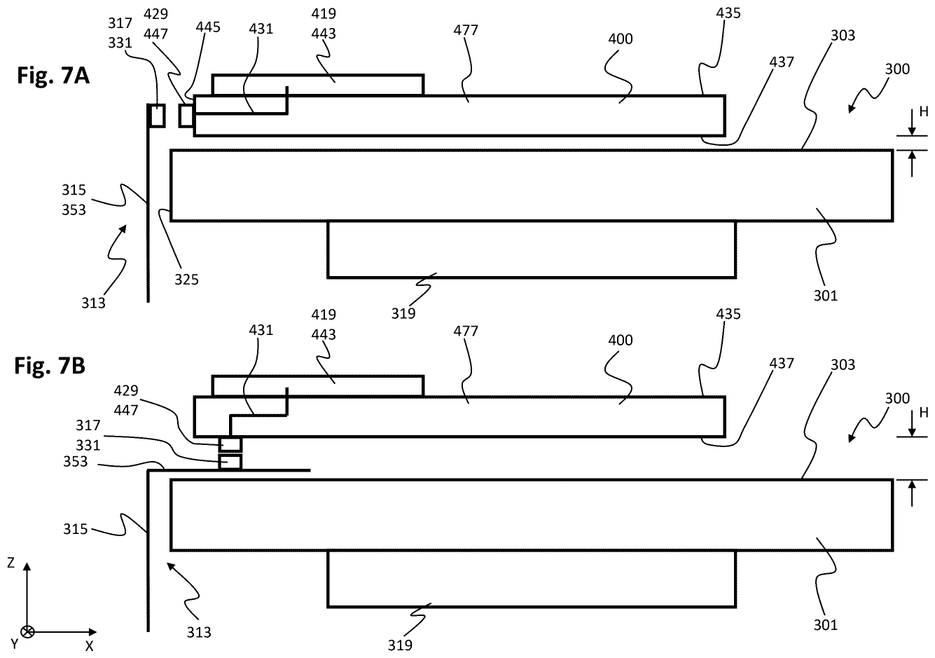

FIGS. 7A and 7B show further schematic depictions of a planar drive system 200 having a stator assembly 300, a rotor 400 and an energy transfer structure 313 according to a further embodiment.

In the embodiment shown, the transfer units 317 of the energy transfer structure 313 and the transfer counter units 429 of the rotor 400 are each embodied as induction coils 331, 447.

In FIG. 7A, the contacting arm 353 is rectilinear and oriented perpendicular with regard to the stator surface 303 of the stator assembly 300. The energy transfer structure 313 is again arranged laterally with regard to the stator module 301 shown.

The transfer counter unit 429 of the rotor 400 is arranged at a lateral area 445 of the rotor 400.

As an alternative, in a further embodiment, the transfer counter unit 429 may also be arranged on the rotor 400. The induction coil 447, on the other hand, could be arranged further on the lateral area 445. The electronics of the transfer counter unit 429, which is connected to the induction coil 447 at the lateral area 445, could thus be arranged on the rotor 400.

The induction coil 447 of the rotor 400 thus points away from the lateral area 445 of the rotor 400. The induction coil 331 of the energy transfer structure 313, on the other hand, points towards the lateral area 325 of the stator assembly 300. The energy transfer position of the rotor 400 relative to the energy transfer structure 313 is in this context determined by the fact that the two induction coils 331, 447 face each other. For this purpose, the rotor 400 moves to the edge region 325 of the stator assembly 300 or the stator module 301 and orients the induction coil 447 in the direction of the induction coil 331 of the energy transfer structure 313. The rotor 400 may also vary the flying height H to align the induction coils 331, 447 with one another.

In the embodiment shown in FIG. 7B, the contacting arm 353 of the energy transfer structure 313 is arranged in parallel with regard to the stator surface 303 of the stator module 301. The contacting arm 353 is thus arranged at right angles to the base structure 315 of the energy transfer structure 313.

The induction coil 331 arranged on the contacting arm 353 is thus arranged in parallel with regard to the stator surface 303 and points away from it.

In the embodiment shown, the induction coil 447 of the rotor 400 is embodied on the underside 437 of the rotor 400. In the embodiment shown, the induction coil 447 is in turn arranged on the lateral area 445 of the rotor 400. For energy transfer, the induction coil 331 of the energy transfer structure 313 is thus arranged between the stator assembly 300 and the rotor 400.

Alternatively, a plurality of induction coils 447 may be embodied on the rotor 400, for example on different lateral areas 445.

In order to position the rotor 400 in the energy transfer position, the rotor is thus moved over the induction coil 331 of the energy transfer structure 313 in such a way that the two induction coils 331, 447 are arranged on top of one another. To optimize the contactless energy transfer between the induction coils 331, 447, the flying height H of the rotor 400 may also be varied.

In the embodiments shown in FIG. 7A and FIG. 7B, the battery unit 443 of the energy storage 419 is connected to the induction coil 447 of the rotor 400 via the energy transfer connection 431. In the embodiments shown, the electrical connection runs within the rotor base 477.

The energy transfer structure 313 may be arranged at a predefined energy transfer position along the stator assembly 300. For energy transfer, the rotor 400 is positioned accordingly in the energy transfer position. Energy is then transferred from the energy transfer structure 313 to the rotor 400 when the rotor 400 is stationary.

Alternatively, the energy transfer structure 313 may be arranged over a predefined distance along the stator assembly 300. The energy transfer from the energy transfer structure 313 to the rotor 400 may then take place while the rotor 400 is moving along the energy transfer structure 313. However, energy may also be transferred in this embodiment when the rotor 400 is stationary.

The energy transfer structure 313 arranged along the predefined path may comprise a plurality of induction coils 331 arranged next to one another. For energy transfer, taking into account position information of the rotor 400, which defines an exact position specification of the rotor 400 relative to the stator assembly 300, the energy transfer coil 331, with regard to which the rotor 400 is located at a predefined transmission distance, may be energized when the rotor 400 is stationary or while the rotor 400 is moving. The transfer distance may be defined as a function of the power of the respective induction coils 331, 447.

The position of the rotor 400 is determined by measuring the rotor magnetic field of the magnetic unit 407 of the rotor 400 using magnetic field sensors embodied in the stator assembly.

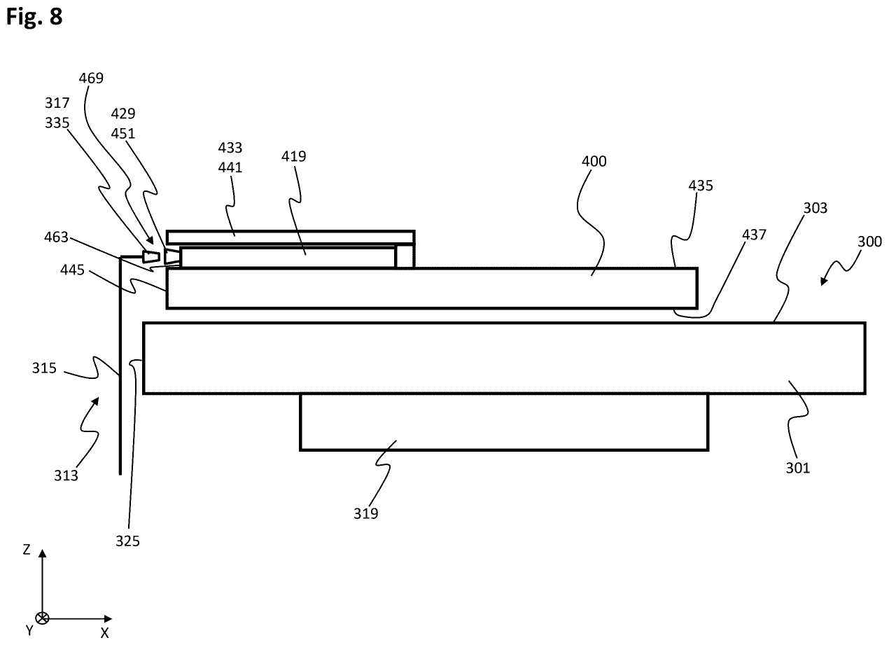

FIG. 8 shows a further schematic depiction of a planar drive system 200 having a stator assembly 300, a rotor 400 and an energy transfer structure 313 according to a further embodiment.

In the embodiment shown, the energy storage 419 is again arranged in the fixing mechanism 433 at the rotor 400. The fixing mechanism 433 is again embodied as a housing 441. The housing 441 comprises an output opening 469. The output opening 469 is arranged at the edge region 445 of the rotor 400. At the lateral area 463 of the energy storage unit 419, the energy storage unit 419 comprises the transfer counter unit 429.

In the embodiment shown, the energy transfer structure 313 is again arranged laterally to the lateral area 325 of the stator assembly 300. The energy transfer structure 313 comprises the base structure 315 and the contacting arm 353. The base structure 315 is embodied perpendicular with regard to the stator surface 303. The transfer arm 353 is in turn perpendicular with regard to the base structure 315 and thus arranged in parallel with regard to the stator surface 303. The transfer unit 317 is arranged at one end of the contacting arm 353.

In the embodiment shown, the transfer unit 317 is embodied as a plug/socket element. Similarly, the transfer counter unit 429 is embodied as a plug/socket element 451. The plug/socket elements 335, 451 may be coupled to one another by inserting the plug element into the respective socket element.

In order to contact or couple the energy storage 419 with the energy transfer structure 313, the rotor 400 thus moves to the transfer position in which the plug/socket elements 335, 451 are coupled by inserting the plug element into the respective socket element. For this purpose, the flying height H of the rotor 400 may be varied.

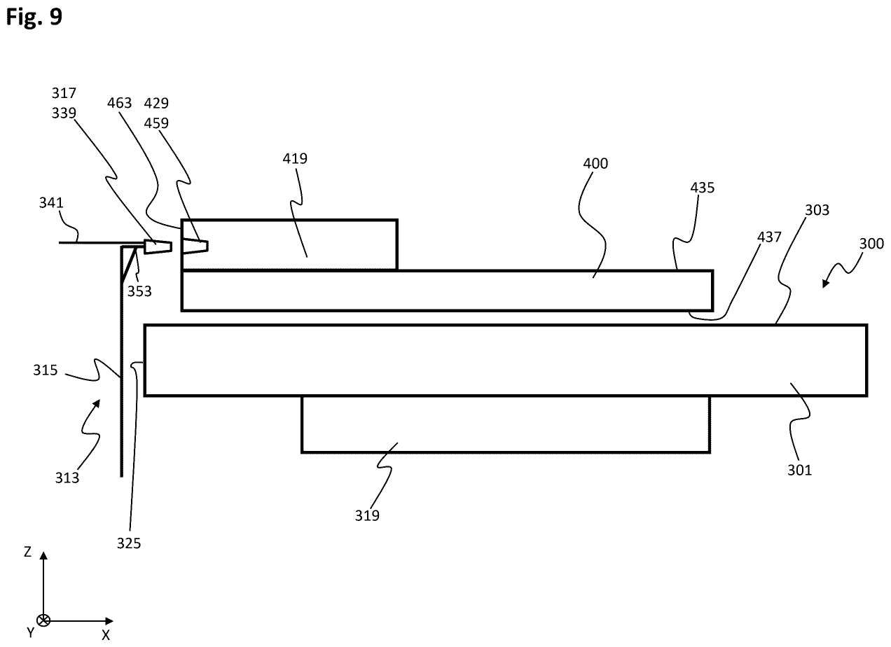

FIG. 9 shows a further schematic depiction of a planar drive system 200 having a stator assembly 300, a rotor 400 and an energy transfer structure 313 according to a further embodiment.

In the embodiment shown, the energy storage 419 is embodied as a media tank 457. The media tank is used to hold an energy-transmitting medium, such as fuel, compressed air or similar energy-transmitting media. An insertion element 459 is also embodied on the media tank 457. The insertion element 459 is embodied on the lateral area 463 of the media tank 457.

The energy transfer structure 313 is arranged laterally at the lateral area 325 of the stator module 301 in a similar way to the energy transfer structure of the embodiment in FIG. 8. On the contacting arm 353 running parallel with regard to the stator surface 303, the transfer unit 317 is embodied in the form of a nozzle element 339. The nozzle element 339 may be coupled to the insertion element 459 and allows for the energy-transferring medium to be transferred from the energy transfer structure 313 into the media tank 457. The nozzle element is also connected to a supply line 341, via which the energy-transferring medium may be transferred.

Analogous to the embodiment in FIG. 8, the rotor 400 is maneuvered into the transfer position for energy transfer, in which the nozzle element 339 is inserted into the insertion element 459.

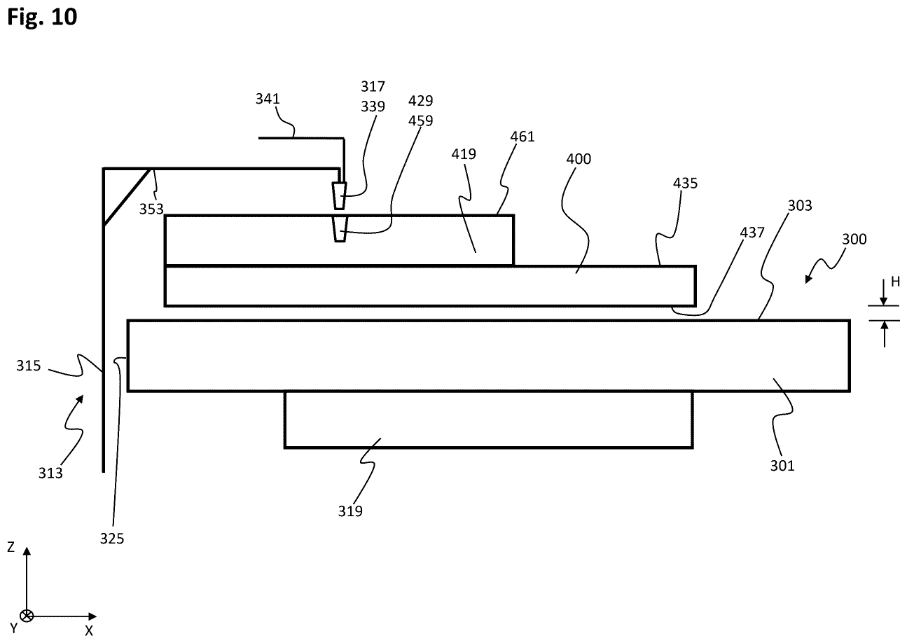

FIG. 10 shows a further schematic depiction of a planar drive system 200 having a stator assembly 300, a rotor 400 and an energy transfer structure 313 according to a further embodiment.

The embodiment shown is based on the embodiment in FIG. 9. Deviating from this, the insertion element 459 is embodied on an upper side 461 of the media tank 457. In the embodiment shown, the nozzle element 339 points in the direction of the stator surface 303 of the stator assembly 300. For energy transfer, the rotor is maneuvered into the transfer position in which the nozzle element 339 is arranged opposite to the insertion element 459. By varying the flight height H, in particular by increasing the flight height H, the nozzle element 339 is inserted into the insertion element 459.

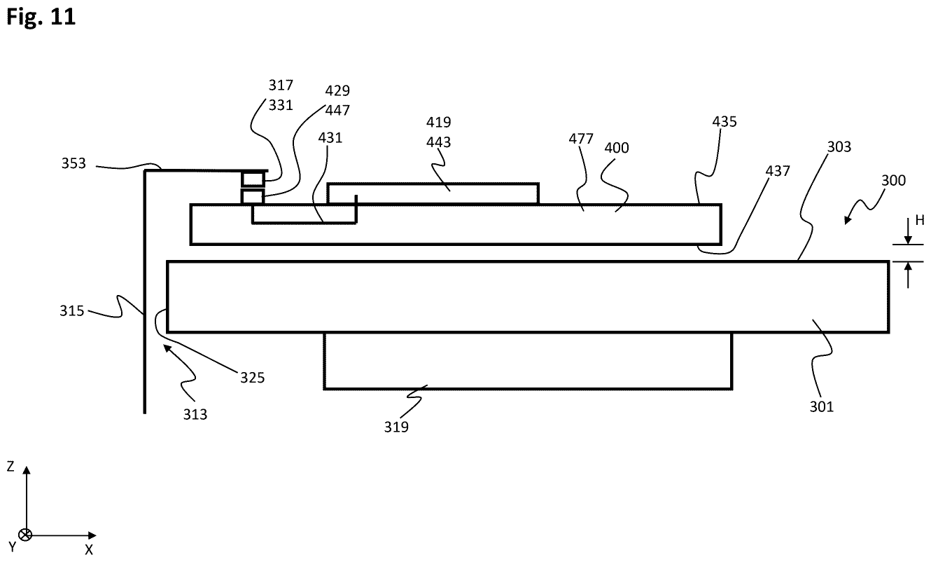

FIG. 11 shows a further schematic depiction of a planar drive system 200 having a stator assembly 300, a rotor 400 and an energy transfer structure 313 according to a further embodiment.

The embodiment shown is based on the embodiment shown in FIG. 7B. In contrast to the embodiment shown there, the induction coil 331 is arranged on the contacting arm 353 oriented in parallel with regard to the stator surface 303 in such a way that the induction coil 331 faces the stator surface 303. In the embodiment shown, the induction coil 447 of the rotor 400 is arranged on the upper side 435 of the rotor 400.

In order to transfer energy, the rotor 400 is thus arranged between the stator assembly 300 and the induction coil 331 of the energy transfer structure 313. Analogously to the embodiment of FIG. 7B, the position of the rotor is aligned for energy transfer in such a way that the two induction coils 331, 447 are arranged on top of one another. To optimize the energy transfer, the flying height H may be varied, in particular increased.

As an alternative, the planar drive system 200 may include a plurality of energy transfer structures 313 disposed at different locations, such as along the stator assembly 300. For example, the plurality of energy transfer structures 313 may be embodied on opposite sides of the stator assembly 300.

The rotor 400 may thus be supplied with energy from different energy transfer structures 313 at different points on the stator assembly 300. As an alternative or in addition, the rotor 400 may simultaneously contact a plurality of energy transfer structures 313 and obtain energy from them.

For example, different energy transfer structures 313 may provide different types of energy such as electrical, thermal, chemical, mechanical energy. As mentioned above, the rotor 400 may comprise correspondingly different transfer counter units 429, each of which is suitable for transmitting energy of a specific type.

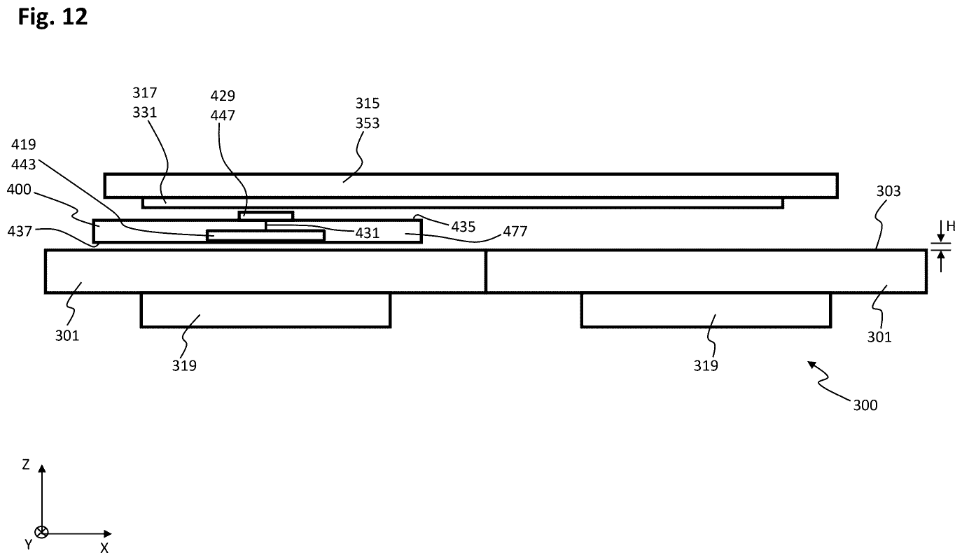

FIG. 12 shows a further schematic depiction of a planar drive system 200 having a stator assembly 300, a rotor 400 and an energy transfer structure 313 according to a further embodiment.

The embodiment in FIG. 12 is based on the embodiment of FIG. 11. The embodiment shown differs from the embodiment in FIG. 11 in that the induction coil 331 of the energy transfer structure 313, which is embodied in parallel with regard to the stator surface 303, is embodied flat on the contacting arm 353. The contacting arm 353 may also be embodied as a flat contacting arm. The rotor 400 is also arranged between the stator surface 303 and the induction coil 331 of the energy transfer structure 313 for energy transfer.

In the embodiment shown, however, the rotor 400 does not have to be moved into a predefined transfer position for energy transfer 400 due to the flat embodiment of the induction coil 331, the dimensions of which are larger than the dimensions of the rotor 400. Instead, as shown in FIG. 12, the rotor 400 may be moved underneath the induction coil 331 of the energy transfer structure 313. While the rotor 400 is moving, the corresponding energy transfer from the energy transfer structure 313 to the rotor 400 takes place via the contactless energy transfer between the mutually facing induction coils 331, 447. In the embodiment shown, the energy storage 419 in the form of the battery unit 443 is arranged inside the rotor base 477.

In the embodiment shown, the energy transfer structure 313 may be arranged, for example, on a ceiling structure or on a suspension structure above the stator assembly 300. The energy transfer structure 313 embodied in this way may at least partially cover the stator surface 303 of the stator assembly 300. Alternatively, the energy transfer structure 313 may cover the entire stator surface 303.

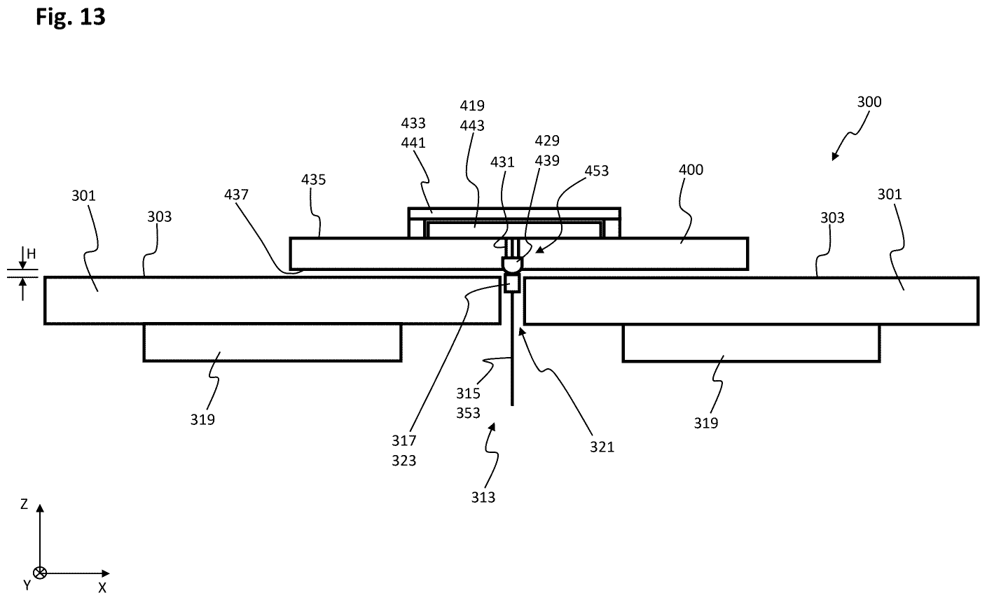

FIG. 13 shows a further schematic depiction of a planar drive system 200 having a stator assembly 300, a rotor 400 and an energy transfer structure 313 according to a further embodiment.

The embodiment shown is based on the embodiment in FIG. 6. Deviating from this, in the embodiment shown the energy transfer structure 313 is not arranged laterally adjacent to the stator assembly 300, but centrally in the stator assembly 300 between two adjacent stator modules 301. For this purpose, a gap 321 is embodied between the adjacent stator modules 301. The contacting arm 353 and the busbar 323 arranged thereon are arranged in the gap 321. The busbar 323 is positioned at the level of the stator surface 303 of the stator modules 301.

In the embodiment shown, the sliding contact 439 of the transfer counter unit 429 is embodied on the underside 437 of the rotor 400. The sliding contact 439 thus faces the busbar 323 arranged on the stator surface 303. The busbar runs along a Y-direction of the coordinate system shown.

When the rotor 400 passes over the busbar 323, contact may thus be made between the busbar 323 and the sliding contact 439, wherein energy is transferred from the energy transfer structure 313 to the energy storage 419.

In this context, the rotor 400 may travel along the busbar 323 until enough energy has been transferred.

For contacting the busbar 323 with the aid of the sliding contact 439, the flying height H of the rotor 400 may also be reduced when the rotor 400 passes over the busbar 323. This makes it possible to ensure that contact with the busbar 323 is only made by reducing the flying height H and thus that energy is only transferred when this is intended. On the other hand, no energy transfer takes place when passing over the busbar 323 at an increased flying height H.

In the drawing shown, the flying height H is defined between the stator surface 303 and the underside 437 of the rotor. Alternatively, the flight height H may be defined between the stator surface 303 and the top surface 435 of the rotor. Alternatively, the flight height H may be defined between the stator surface 303 and a center between the top surface 435 and the bottom surface 437 of the rotor 400 or any other spatial point relative to the rotor 400.

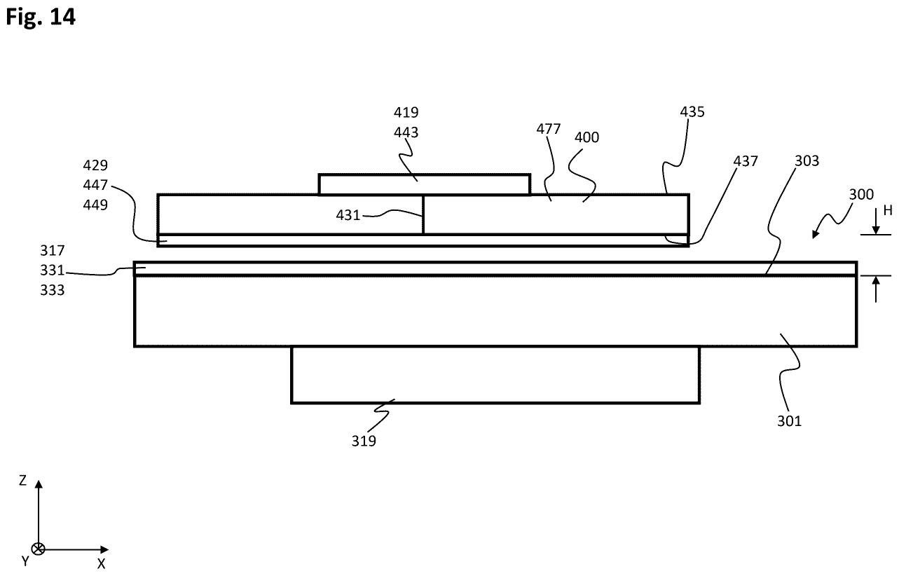

FIG. 14 shows a further schematic depiction of a planar drive system 200 having a stator assembly 300, a rotor 400 and an energy transfer structure 313 according to a further embodiment.

In the embodiment shown, the induction coils of the preceding embodiments are each embodied as induction layers 449, 333. In this context, the induction layer 333 of the energy transfer structure 313 is arranged on the stator surface 303 of the stator assembly 300 in the embodiment shown. In the embodiment shown, the entire stator surface 303 of the stator module 301 shown is covered by the induction layer 333. The induction layer 449 of the rotor 400, on the other hand, is embodied on the underside 437 of the rotor 400. In the embodiment shown, the entire underside 437 of the rotor 400 is covered by the induction layer 449.

In order to transfer energy from the energy transfer structure 313, which in the embodiment shown is only embodied by the induction layer 333, the rotor 400 therefore only has to pass over the induction layer 333. A predefined energy transfer position is therefore not necessary in the embodiment shown. In order to optimize the energy transfer, the flying height H of the rotor 400 may be varied.

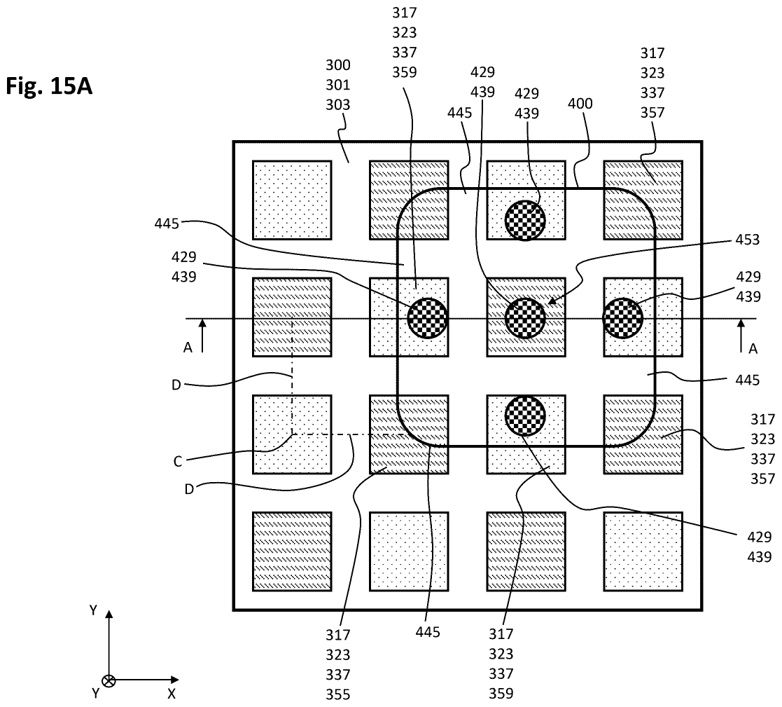

FIGS. 15A-15C show further schematic depictions of a planar drive system 200 having a stator assembly 300, a rotor 400 and an energy transfer structure 313 according to a further embodiment.

The embodiments in FIGS. 15A-15C are based on the embodiment in FIG. 13. The busbar 323 is again arranged at the level of the stator surface 303 of the stator assembly. In the embodiment shown, however, the embodiment of the busbar 323 differs from the embodiment of FIG. 13 in that the busbar 323 is embodied as a type of flat busbar foil 355 and consists of a plurality of contacting elements 337 separated from one another. In the embodiment shown, the contacting elements 337 are rectangular in shape as shown in FIG. 15A and are evenly spaced apart over the entire surface of the stator module 301 shown.

The contacting elements 337 may each comprise an electrical + pole or an electrical − pole.

In the embodiment shown, the contacting elements 337 are each embodied as a + pole contacting element 357 or as a − pole contacting element 359, wherein the + pole contacting elements 357 each form an electrical + pole and the − pole contacting elements 359 each form an electrical − pole. In the embodiment shown, the + pole contacting elements 357 and the − pole contacting elements 359 are each arranged at a distance from one another in such a way that, in any position of the rotor 400 on the stator assembly 300, the rotor 400 contacts at least one + pole contacting element 357 and at least one-pole contacting element 359.

In FIG. 15A, the + pole contacting elements 357 are indicated by a dotted line pattern and the − pole contacting elements 359 with a dotted pattern.

As an alternative to the embodiment shown, a + pole contacting element 357 and a − pole contacting element 359 may each be combined in a contacting element 337.

In the embodiment shown, the rotor 400 also comprises five sliding contacts 439. As shown in FIG. 15B and FIG. 15C, the sliding contacts 439 are embodied to protrude from the underside 437 of the rotor 400 in such a way that they face the stator surface 303. The sliding contacts 439 also each have a + pole and a − pole.

As may be seen in FIG. 15A on the basis of a transparent depiction of the rotor 400, four of the five sliding contacts 439 are arranged on the lateral areas 445 of the rectangular rotor 400, which are opposite to each other in pairs. A fifth sliding contact 439, on the other hand, is arranged in a center 453 of the rotor. In the position shown, the sliding contact 439 arranged in the center 453 of the rotor 400 contacts a + pole contacting element 357. The sliding contacts 439 arranged on the lateral areas 445, on the other hand, each contact a − pole contacting element 359.

The simultaneous contacting of at least one + pole contacting element 357 and at least one − pole contacting element 359 by a sliding contact 439 in each case allows for energy to be optimally transferred to the rotor 400.

FIG. 15A also shows that the contacting elements 337 of the busbar 323 are arranged at a distance D relative to one another. The distances D are in this context defined between centers C of two contacting elements 337 that are arranged at an immediate distance from each other.

The distances D between the contacting elements 337 may be defined in such a way that, for a plurality of charging positions of the rotor relative to the stator assembly 300, at least one sliding contact 439 contacts at least one contacting element 337 of the busbar 323. The distances D are thus adapted to the proportions of the rotor 400 or the arrangement of the sliding contacts 439 at the rotor 400. In a charging position, this ensures that at least one + pole contacting element 357 and at least one-pole contacting element 359 are contacted by the sliding contacts 439 of the rotor 400.

As already described in context with the embodiment of FIG. 13, a sliding contact between the sliding contacts 439 of the rotor 400 and the contacting elements 337 of the busbar 323 of the stator assembly 300 may be achieved by varying the flying height H, in particular by reducing the flying height H.

Thus, FIG. 15B shows the rotor 400 at a flying height H that is dimensioned in such a way that no sliding contact is made. In contrast, FIG. 15C shows the rotor 400 at a lower flying height H, in which sliding contact is made between the contacting elements 337 and the sliding contacts 439. This sliding contact may be achieved in particular during the process, i.e. the movement of the rotor 400 relative to the stator assembly 300.

Energy transfer takes place each time the sliding contacts 439 of the rotor 400 contact both at least one + pole contacting element 357 and at least one-pole contacting element 359. In the positions of the rotor 400 in which the sliding contacts 439 do not simultaneously contact at least one + pole contacting element 357 and at least one-pole contacting element 359, on the other hand, no energy transfer takes place.

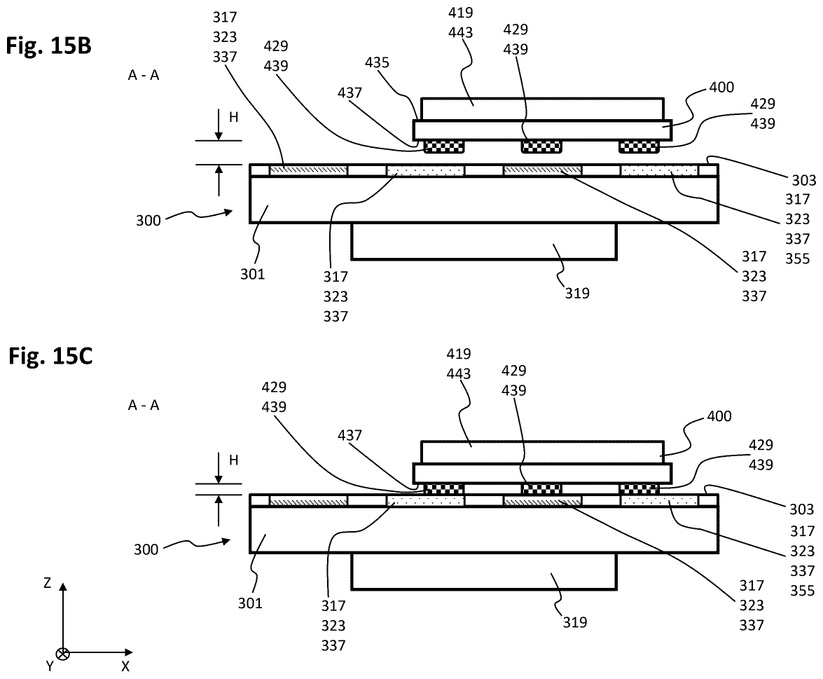

FIGS. 16A and 16B show further schematic depictions of a rotor 400 having an energy storage 419 according to a further embodiment.

In the embodiment shown, the energy storage is detachably arranged at the rotor 400 via the fixing mechanism 433. In the embodiments shown in FIG. 16A and FIG. 16B, the fixing mechanism 433 is embodied as a housing 441. Latching elements 475 are embodied on lateral areas 479 of the housing 441, via which the energy storage 419 is latched in the housing 441. Furthermore, a trigger element 471 is embodied on a ceiling area 481. The trigger element 471 may trigger the latching of the energy storage 419 via the latching elements 475 in the housing 441, so that the energy storage 419 may be removed from the housing 441.

In FIG. 16B, the housing 441 comprises the housing opening 469. The latching element 475 is arranged opposite to the housing opening 469 in the lateral area 479. By releasing the latch, the energy storage 419 may be removed from the housing 441 and thus from the rotor 400 through the housing opening 469 arranged on the lateral area 445 of the rotor 400.

The energy storage 419, or a further energy storage of identical embodiment, may accordingly be arranged and fixed on the rotor 400 via the fixing mechanism 433 by inserting the energy storage 419 into the fixing mechanism 433 and fixing it there.

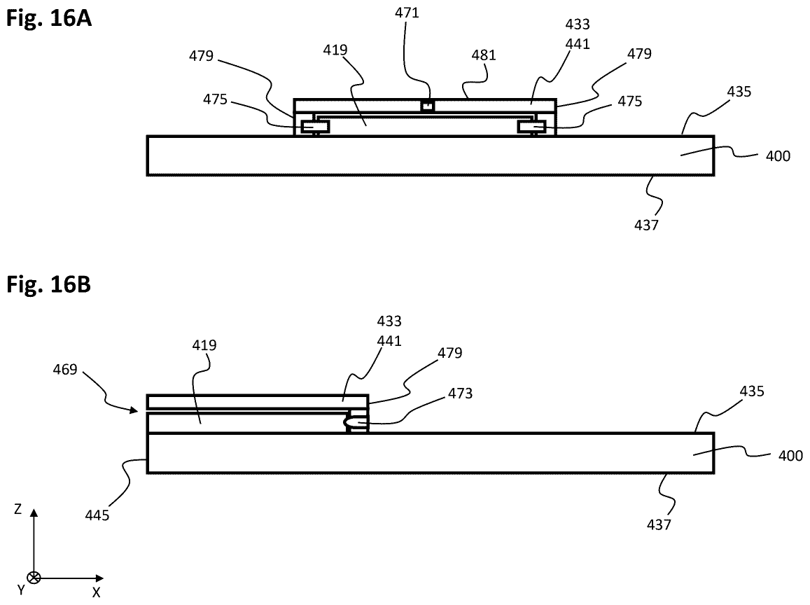

FIG. 17 shows a schematic depiction of a planar drive system 200 having a stator assembly 300, a rotor 400 and a trigger structure 343 according to an embodiment.

The embodiment shown is based on the embodiment of FIG. 16B. In the embodiment shown, the fixing mechanism 433 comprises the aforementioned trigger element 471 on the lateral area 479 of the housing opening 469. In analogy to the embodiment in FIG. 16B, the housing 441 comprises the aforementioned ejector element 473 on the lateral area 479 opposite to the housing opening 469. The ejector element 473 may, for example, be embodied by a spring element. By activating the trigger element 471, the ejector element 473 is activated and the energy storage 419 is ejected from the housing 441.

In the embodiment shown, the planar drive system 200 further comprises a trigger structure 343. The trigger structure 343 is disposed laterally at the side portion 325 of the stator module 301 shown. The trigger structure 343 comprises a trigger base structure 349, which is arranged perpendicular with regard to the stator surface 303. Perpendicular with regard to the trigger base structure 349, the trigger structure 343 further comprises an activation projection 345. The activation projection 345 is arranged perpendicular with regard to the trigger base structure 349 and thus in parallel to the stator surface 303. At a distance from the activation projection 345, the trigger structure 343 comprises a base region 351. A receiving region 347 is defined between the activation projection 345 and the base region 351.

In order to trigger or to eject the energy storage 419, the rotor 400 is maneuvered into an ejection position relative to the trigger structure 343. In the ejection position, the triggering projection 345 contacts the trigger element 471 of the fixing mechanism 433. By triggering the trigger element 471, the ejection element 473 is activated and the energy storage 419 is ejected via the housing opening 469 into the receiving area 347 of the trigger structure 343.

The energy storage 419 may thus be removed from the fixing mechanism 433 merely by maneuvering the rotor into the position provided for this purpose and by the resulting adjacency of the trigger projection 345 to the trigger element 471 and thus transferred from the rotor 400 to the trigger structure 343. The embodiment of the trigger structure 343 shown is merely exemplary.

The core idea of the embodiment shown is that the energy storage 419 is removed from the rotor 400 solely by maneuvering the rotor 400 into a position provided for this purpose. Active removal of the energy storage 419 from the rotor 400 by actuating corresponding moving components may thus be avoided.

The energy storage 419 or a further energy storage of identical design may be arranged at and fixed to the rotor 400 via the fixing mechanism 433, in that the energy storage 419 is pushed into the fixing mechanism 433 accordingly and fixed therein.

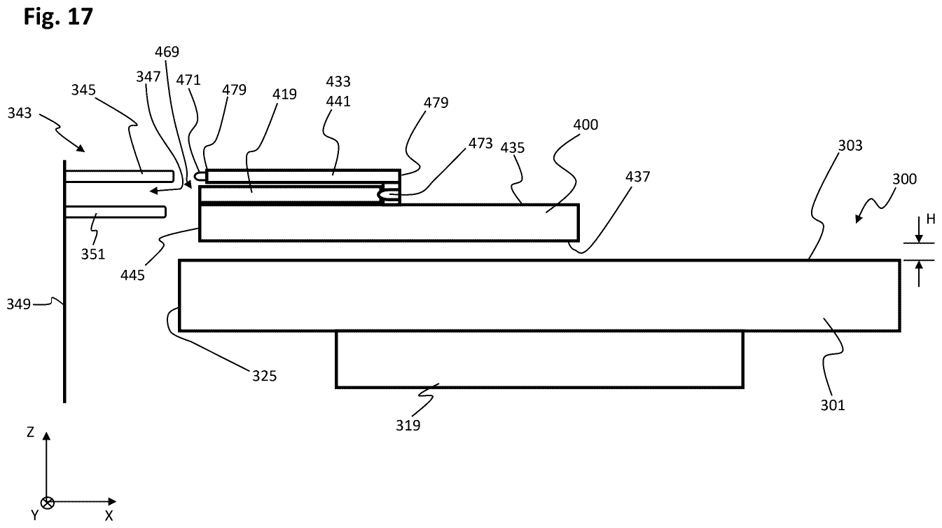

FIG. 18 shows a flowchart of a method 100 for transferring energy to a rotor 400, 423 of a planar drive system 200 according to an embodiment.

In the embodiment shown, control signals for positioning the rotor 400 in an energy charging position relative to the energy transfer structure 313 are output by the controller 201 to at least one coil group of the stator assembly 300 in a first outputting step 101 for transferring energy to a rotor 400. The energy charging position is characterized by the fact that a coupling between the transfer unit 317 of the energy transfer structure 313 and the transfer counter unit 429 of the rotor 400 and thus an energy transfer from the energy transfer structure 313 to the rotor 400 is allowed for.

In a second outputting step 103, the controller 201 outputs control signals to the energy transfer structure 313. The energy transfer structure 313 is controlled by the control signals to transfer the energy to the rotor 400.

The controller 201 may regulate the amount and/or type of energy to be transmitted.

For this purpose, the controller 201 may be embodied as a central controller that controls the movement of the rotors 400, 423 and additionally controls or at least monitors the processes carried out by the process devices 427. The controller 201 is thus informed about the amounts of energy required to execute the respective processes and available to the rotors 400, 423.

As an alternative or in addition, the rotors 400, 423 may be arranged to actively communicate with the controller 201 and to inform the controller 201 that a certain amount of energy is required to carry out a certain process and/or that an available amount of energy is not sufficient to carry out a certain process.

The rotor 400 may thus indicate to the controller 201 and/or the energy transfer structure 313 the amount of energy to be transferred.

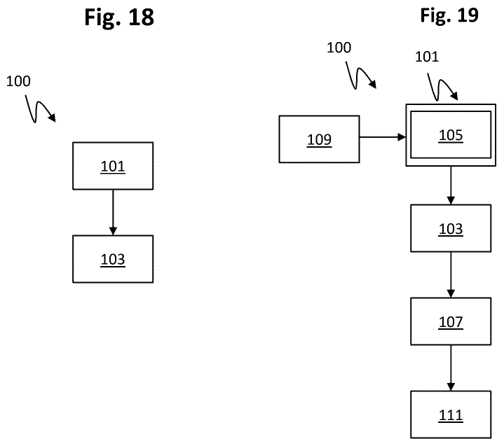

FIG. 19 shows a flowchart of the method 100 for transferring energy to a rotor 400, 423 of a planar drive system 200 according to a further embodiment.

The embodiment shown is based on the embodiment in FIG. 18 and comprises all the method steps described therein.

In the embodiment shown, the first outputting step 101 comprises a third outputting step 105.

In the third outputting step 105, the controller 201 outputs control signals to at least one coil group for varying the flying height H of the rotor 400 in the energy transfer position and for contacting the transfer unit 317 of the energy transfer structure 313 by the transfer counter unit 429 of the rotor 400.

According to the embodiments described above, the flying height H may be increased or decreased depending on the embodiment of the energy transfer structure 313 for contacting the transmission or transfer counter units 319, 429. The flying height H may be varied by actuating the stator magnetic fields accordingly.

Furthermore, in the embodiment shown, in order to remove the energy storage 419 from the rotor 400 in a fifth outputting step 109, corresponding control signals may be output by the controller to at least one coil group in order to move the rotor 400 to an ejection position. In the ejection position, the rotor 400 is positioned relative to the trigger structure 343 described above in such a way that the activation projection 345 of the trigger structure 343 is adjacent to the trigger element 471 of the fixing mechanism 433 of the rotor 400 and the ejection element 473 of the fixing mechanism 433 is activated in this manner. By activating the ejection element 473, the energy storage 419 is automatically ejected from the fixing mechanism 433 and picked up by the receiving area 347 of the trigger structure 343.

The fifth outputting step 109 and the ejection of the energy storage 419 may be carried out before the first outputting step 101. A replacement of the energy storage 419 is described in this context. For this purpose, a new energy storage 419 is first installed on the rotor 400 before the energy transfer is executed.

Alternatively, the newly installed energy storage unit 419 may already be filled with energy, for example as a charged battery unit. The energy storage unit may then be replaced as an alternative to carrying out the energy transfer from the energy transfer structure 313 to the rotor 400.

As an alternative or in addition, energy may also be transferred between two rotors 400, 423.

For this purpose, in a fourth outputting step 107 control signals are first output by the controller 201 to at least one coil group of the stator assembly 300 for positioning the rotor 400 in a transfer position relative to a further rotor 423 of the planar drive system 200 and for contacting the energy transfer element 421 with the energy transfer counter element 425 of the further rotor 423 and for transmitting the amount of energy required to execute the process device 427 to the further rotor 423.

As described above, in this context the transfer position is not defined by an explicit position of the rotors 400, 423 relative to the stator assembly 300. The transfer position is defined by a relative position of the two rotors 400, 423 relative to each other and is characterized by the coupling of the transmission or transfer counter elements 421, 425 of the two rotors 400, 423.

In a transferring step 111, energy is subsequently transferred from the rotor 400 to the further rotor 423 or from the further rotor 423 to the rotor 400. The further rotor 423 may also be provided with an energy storage 419 for this purpose.

The energy transfer may be controlled by the controller 201 in that the controller 201 outputs corresponding control signals to the rotors 400, 423, which cause an energy transfer.

Alternatively, the energy transfer may be controlled independently with the aid of the rotors 400, 423. For this purpose, the rotors 400, 423 may each comprise a communication unit and a controller, with the aid of which data communication may be carried out between the rotors 400, 423, in which, for example, the amount and/or type of energy to be transmitted is communicated, and the energy transfer is controlled independently by the rotors 400, 423.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals: 100-359

100 Method
101 First outputting step
103 Second outputting step
105 Third outputting step
107 Fourth outputting step
109 Fifth outputting step
111 Transferring step
200 Planar drive system
201 Controller
203 Data connection
300 Stator assembly
301 Stator module
303 Stator surface
305 Stator module housing
307 Connection cable
308 Stator segment
309 Stator conductor
311 Contact structure
313 Energy transfer structure
315 Basic structure
317 Transfer unit
319 Stator base
321 Gap
323 Busbar
325 Lateral area of the stator assembly
327 Process device
329 Sliding contact
331 Induction coil
333 Induction layer
335 Plug/socket element
337 Contacting element
339 Nozzle element
341 Supply line
343 Trigger structure
345 Activation projection
347 Receiving area
349 Trigger base structure
351 Bottom area
353 Contacting arm
355 Busbar foil
357 +Pole Contacting element
359 −Pole contacting element

TABLE 2
List of reference numerals: 400-501

400 Rotor
401 Magnet arrangement
403 Free space
405 Fastening structure
407 Magnetic assembly
409 Magnetic element
411 First X-magnet assembly
413 Second X-magnet assembly
415 First Y-magnet assembly
417 Second Y-magnet assembly
419 Energy storage
421 Energy transfer element
423 Further rotor
425 Energy transfer counter element
427 Process device
429 Transfer counter unit
431 Energy transfer connection
433 Fixing mechanism
435 Top side
437 Underside
439 Sliding contact
441 Housing
443 Battery unit
445 Lateral area of the rotor
447 Induction coil
449 Induction layer
451 Plug/socket element
453 Center
455 Edge structure
457 Media tank
459 Insertion element
461 Top side of energy storage unit
463 Lateral area of energy storage unit
465 Further energy storage
467 Further energy transfer connection
469 Output opening
471 Trigger element
473 Ejector element
475 Latching element
477 Rotor base
479 Lateral area
481 Ceiling area
500 Sensor module
501 Magnetic field sensor
D Distance
H Flying height
C Center

1. A planar drive system, wherein the planar drive system comprises:
a stator assembly having a plurality of coil groups for generating a stator magnetic field, and
at least one rotor having a plurality of magnet assemblies for generating a rotor magnetic field;
wherein the rotor is drivable on the stator assembly via a magnetic coupling between the stator magnetic field and the rotor magnetic field,
wherein the rotor comprises an energy storage,
wherein an energy transfer structure having a transfer unit is configured on the stator assembly,
wherein the rotor comprises a transfer counter unit which is couplable to the transfer unit, and
wherein an energy transfer from the energy transfer structure to the rotor is enabled when the transfer unit is coupled to the transfer counter unit.

2. The planar drive system according to claim 1, wherein:
the energy transfer structure comprises a contacting arm,
wherein the transfer unit is configured on the contacting arm, and
wherein the contacting arm is arranged at least partially above a stator surface of the stator assembly.

3. The planar drive system according to claim 1, wherein the transfer counter unit is laterally arranged, and/or configured on an underside facing the stator surface, or on an upper side of the rotor opposite to the underside.

4. The planar drive system according to claim 1, wherein the transfer unit and the transfer counter unit comprise induction coils.

5. The planar drive system according to claim 1, wherein:
the transfer unit and the transfer counter unit each comprise an induction layer,
wherein the transfer unit is arranged on the stator surface of the stator assembly, and
wherein the transfer counter unit is arranged on an underside of the rotor facing the stator surface.

6. The planar drive system according to claim 1, wherein;
the transfer unit comprises a bus bar, and
wherein the transfer counter unit comprises a sliding contact.

7. The planar drive system according to claim 6, wherein:
the bus bar is configured in a stator surface of the stator assembly, and
wherein the sliding contact is configured on an underside of the rotor facing the stator surface.

8. The planar drive system according to claim 6, wherein:
the busbar comprises a plurality of contacting elements,
wherein the contacting elements are arranged at predetermined distances with regard to one another on the stator assembly,
wherein a plurality of sliding contacts arranged at a distance with regard to one another is configured on the rotor, and
wherein the predefined distance is defined such that in a plurality of charging positions of the rotor on the stator assembly, contact is enabled between at least one contacting element of the stator assembly and a sliding contact of the rotor.

9. The planar drive system according to claim 1, wherein the coupling between the transfer unit of the energy transfer structure and the transfer counter unit of the rotor is enabled via a variation of a flying height (H) of the rotor above the stator surface.

10. The planar drive system according to claim 1, wherein the energy storage is arranged on an upper side of the rotor or integrated into a rotor base of the rotor or integrated into an edge structure of the rotor; or arranged with a flat configuration on the rotor base of the rotor, forming an upper side of the rotor.

11. The planar drive system according to claim 1, wherein:
the energy storage is releasably fixed to the rotor by a fixing mechanism, and
wherein the fixing mechanism comprises a latching connection and/or plug connection.

12. The planar drive system according to claim 1, wherein:
the planar drive system further comprises a trigger structure arranged on the stator assembly,
wherein the trigger structure comprises an activation projection and a receiving area, and
wherein the fixing mechanism comprises a trigger element;
wherein the planar drive system is arranged by moving the rotor into an ejection position on the stator assembly, pressing the trigger element against the activation projection and thereby triggering it, and
wherein the energy storage is ejected from the fixing mechanism into the receiving region of the trigger structure by triggering the trigger element.

13. The planar drive system according to claim 1, wherein:
the rotor and/or the further rotor comprises a process device, and
wherein the process device is drivable with the energy of the energy storage.

14. The planar drive system according to claim 1, wherein the energy storage comprises an electric battery unit and/or a compressed air tank and/or a gas tank and/or a fuel tank.

15. The planar drive system according to claim 1, wherein:
the rotor comprises an energy transfer element connected to the energy storage, and
wherein the energy transfer element is couplable to an energy transfer counter element of a further rotor;
wherein an energy transfer from the rotor to the further rotor is enabled when the energy transfer element is coupled to the energy transfer counter element, and/or
wherein the energy transfer element of the rotor and the energy transfer counter element of the further rotor are each configured as a plug connection with a plug element and/or a socket element, or as an induction coil.

16. A rotor configured for a planar drive system according to claim 1, wherein the rotor comprises at least one energy storage, a transfer counter unit and/or an energy transfer element.

17. A method for transmitting energy to a rotor in a planar drive system according to claim 1, wherein:
the planar drive system comprises a controller, a stator assembly and a rotor,
wherein an energy transfer structure having a transfer unit is configured on the stator assembly, and
wherein the rotor comprises a transfer counter unit that is couplable to the transfer unit;
wherein the method comprises:
outputting of control signals by the controller to at least one coil group of the stator assembly for positioning the rotor in an energy charging position relative to the energy transfer structure in a first outputting step,
wherein in the energy charging position a coupling is enabled between the transfer unit of the energy transfer structure and the transfer counter unit of the rotor and an energy transfer is enabled from the energy transfer structure to the rotor associated with the coupling; and
outputting of control signals by the controller to the energy transfer structure for executing the energy transfer from the energy transfer structure to the rotor in a second outputting step.

18. The method according to claim 17, wherein the first outputting step comprises outputting of control signals by the controller to at least one coil group for varying a flying height (H) of the rotor in the energy charging position and for coupling the transfer unit of the energy transfer structure and the transfer counter unit of the rotor in a third outputting step.

19. The method according to claim 17, further comprising:
outputting of control signals by the controller to at least one coil group for controlling the rotor into an ejection position in a fourth outputting step,
wherein, in the ejection position, a trigger element of a fixing mechanism with which the energy storage is fixed to the rotor adjoins an activation projection of a trigger structure arranged on the stator assembly and is triggered thereby, and
wherein the energy storage is ejected from the fixing mechanism by triggering the trigger element and is received by a receiving region of the trigger structure.

20. The method according to claim 17, wherein the method further comprises:
outputting of control signals by the controller to at least one coil group of the stator assembly for positioning the rotor in a transfer position relative to a further rotor of the planar drive system in a fifth outputting step,
wherein in the transfer position, a coupling is enabled between an energy transfer element of the rotor with an energy transfer counter element of the further rotor and an energy transfer is enabled from the rotor to the further rotor, and/or an energy transfer is enabled from the further rotor to the rotor; and
further comprising one or more of:
carrying out the energy transfer from the rotor to the further rotor and/or from the further rotor to the rotor in a transferring step, and/or
wherein the energy transfer from the rotor to the further rotor or from the further rotor to the rotor is controlled by the rotors or the controller, and/or
wherein the coupling of the rotor to the further rotor and the transfer of the energy from the rotor to the further rotor takes place during a travel of the rotor and the further rotor, and/or
wherein the controller recognizes that the rotor and/or the further rotor requires an amount of energy and an energy transfer is to be carried out, wherein the rotor and/or the further rotor is configured for providing a corresponding amount of energy, and/or
wherein the rotor and/or the further rotor signal to the controller that an amount of energy is required and an energy transfer is to be carried out by sending a corresponding message to the controller.
